(19) United States
(12) Patent Application Publication
(10) Pub. No.: US 2014/0365363 A1
(43) Pub. Date: Dec. 11, 2014

(54) SECURE INTEGRATIVE VAULT OF CONSUMER PAYMENT INSTRUMENTS FOR USE IN PAYMENT PROCESSING SYSTEM AND METHOD

(71) Applicant: PRAIRIE CLOUDWARE, INC., Omaha, NE (US)

(72) Inventors: Kathryn E. Knudsen, Valley, NE (US); Kent L. Landholm, Elkhorn, NE (US); Michael E. Carter, Cleveland, SC (US); Kevin R. Kammer, Omaha, NE (US); Daniel J. Casson, Council Bluffs, IA (US)

(73) Assignee: Prairie Cloudware, Inc

(21) Appl. No.: 14/299,453

(22) Filed: Jun. 9, 2014

Related U.S. Application Data
(60) Provisional application No. 61/832,575, filed on Jun. 7, 2013.

(51) Int. Cl. G06Q 20/36

(52) U.S. Cl. CPC G06Q 20/3674
USPC 705/41

(57) ABSTRACT

A system and a method is provided for secure storage of consumers' credentials, financial accounts such as credit cards, debit cards, prepaid cards, checking accounts, savings accounts, proprietary gift cards, line of credit accounts, brokerage accounts, loyalty accounts, flexible spending accounts, health savings accounts, or the like, and storage of consumers' financial, legal or other important documents in an integrative vault providing payment processing access, protection, management, control and auditability over all of the consumers' payment instruments, other instruments, and important documents in a cloud based payment transaction processing environment.

The present application claims the benefit of U.S. Provisional Application No. 61/832,575, filed Jun. 7, 2013; which is incorporated by reference herein.

### BACKGROUND OF THE INVENTION

1. Field of the Invention

This disclosure relates to a system and a method of secure transaction processing, and more particularly, to secure processing of such transactions funded by financial accounts stored, managed and controlled via an integrative vault.

2. Description of the Prior Art

When a consumer makes a payment at a merchant, he/she pulls out his/her wallet and determines the payment instrument to be used to facilitate the movement of funds to the merchant in exchange for goods or services. The consumer may select from a number of payment instrument types such as cash, check, credit card, debit card, prepaid card or proprietary gift card. The payment instrument selected depends on any number of tangible and non-tangible reasons such as the instrument types available and preferred in his/her wallet, instrument types accepted by the merchant, the available funds associated with the payment instruments, reward/loyalty incentives, interest rate, and affinity to issuer.

If the consumer elects to use a credit, debit or prepaid card to fund the payment, the payment is initiated when the consumer (payer) physically provides the merchant (payee) with the payment card. A magnetic stripe or contactless reader within the payee's point-of-sale (POS) device reads the payment card details. The device transmits an authorization request, with transaction and payment card details, to a payment processor/payment gateway for routing to a payment network. The payment network routes the authorization request to the payer's card issuer. The issuer approves or declines the transaction and returns an authorization response to the payee via the payment network and payment processor. If approved, the payee submits a settlement transaction to the payee's merchant acquirer to initiate clearing and settlement of the payment among all payment entities.

If the consumer elects to use a check, the payer physically provides the payee with the completed and signed check. Most checks today are read through a merchant's MICR (magnetic ink character recognition) reader, and the check details are electronically transmitted to the merchant's check processor for clearing with the account issuer at the end of the day.

In the last decade, online commerce via the Internet has become increasingly commonplace. With online commerce, the payer cannot physically provide the payee with his/her payment card or check. Rather, the payer enters his/her payment card or bank account details into a payment acceptance portal provided by the merchant website's shopping cart to initiate the payment authorization. In many cases, the payer is given the option to store his/her payment card or bank account details with the merchant for use in future transactions.

In recent years, digital wallets have been introduced to the payments landscape. These wallets allow the consumer to electronically store and manage his/her credit, debit, prepaid, and other cards from his/her smartphone or similar device using a payment application provided by the device or a third party. Rather than carrying around a stack of physical plastic cards, the consumer uses a virtual “card” on his/her smartphone to make a POS purchase. The consumer touches, swipes or taps his/her smartphone to trigger communication of his/her payment credentials from his/her digital wallet to a merchant's POS device, and a payment is initiated.

In alternative digital wallet implementations, the merchant is never presented with payment card details. Rather, the consumer captures merchant and transaction details with his/her smartphone, and transmits a payment authorization to his/her wallet provider/merchant acquirer. Concurrently, the merchant transmits his/her portion of the payment authorization request to the wallet provider/merchant acquirer. The wallet provider/payment processor determines the payment instrument for the consumer, and transmits an authorization request with transaction and payment card details to a payment network for authorization by the issuer, marries the authorized consumer request to the merchant request, then notifies the merchant and consumer of the authorization outcome.

Regardless of the digital wallet implementation, merchant acceptance of any given wallet is spotty due to limitations/incompatibilities of the consumer mobile device and/or merchant POS device, and given the patchwork of wallet provider, merchant, and payment processor agreements. Adding to the number of digital wallets, many merchants offer their own mobile wallets specifically designed for use by their customers.

The existing payment processes expose a number of problems for the payer (consumer) and payee (merchant). Those skilled in the art can easily see how a consumer's payment card and account details may be propagated across numerous merchants' websites, digital wallets, and/or digital wallet provider sites. This has numerous major disadvantages—including security and compliance, convenience and management.

The first disadvantage is security and compliance. With the increasing awareness and growing importance of mobile payments, the mobile channel shows the highest revenue fraud loss rate according to CyberSource's 2013 Online Fraud Report. Moreover, all participants in the payment process (merchants, payment processors/payment gateways, payment networks, and issuers) must comply with various security standards for secure processing of electronic transactions, such as the Payment Card Industry Data Security Standards (PCI DSS). In spite of or due to lack of compliance, there have been a number of highly publicized data breaches at merchants and merchant acquirers where consumer and payment card details have been compromised and used for fraudulent transactions. As a result, industry pundits are recommending that static payment card details not be captured, stored or transmitted by merchants. This is not possible in the current, traditional payments environment as participants are dependent on having the payment card details available for authorization, settlement, and exception processing.

The second disadvantage is lack of convenience for the consumer. Registering payment details at multiple merchant websites and in multiple digital wallets can be time consuming and problematic. While increasing the possibility of payment card and bank account breach exposure, it also creates a management issue for the consumer. This becomes keenly apparent when payment instrument details must be updated. The consumer must remember all of his/her registered sites and/or wallets associated with the payment instrument, and must update each applicable site or wallet in order to initiate future transactions.

In some digital wallets, the specific implementation process may further confound a consumer's ability to obtain a centralized view of all of his/her financial accounts. In staged wallet implementations (Google™ Wallet, PayPal™, LevelUp™, and others), a payment transaction is made against a single payment instrument, typically a prepaid card, which may be linked to one or more other payment cards or accounts. The digital wallet provider authorizes the first payment transaction using the first payment instrument, and then affects a second payment transaction using one of the secondary linked payment cards or accounts to fund the first payment transaction. In the second payment transaction, the digital wallet provider is the merchant of record rather than the merchant where the first payment transaction transpired. This lack of transparency prevents the consumer from obtaining a complete view of his/her spending. Further, there is a lack of a centralized view of his/her financial accounts that would otherwise enable him/her to conveniently manage and control his/her financial assets, and to provide for their secure use in commerce.

Examples of attempts to address the staged wallet disadvantages include Visa™'s V.me and MasterCard™'s MasterPass. These implementations allow the consumer to enter only card associations branded (e.g., Visa, MasterCard, Discover™, and American Express™) credit, debit, and prepaid cards into their wallets, and payment card details or “virtual” payment card details are transmitted to the merchant's payment acceptance device, though payment transaction transparency is maintained with the payment card issuer. A limiting feature is that checks, money orders, direct bank account details, proprietary prepaid/gift cards, and other forms of payments may not be loaded into the wallets. This limited view into a consumer's financial accounts reduces or adds complexity to the consumer's ability to budget and set financial goals.

Paydiant™ (U.S. Pat. No. 8,380,177) and PayPal™ have tried to address these disadvantages. While they allow the consumer to use bank accounts in addition to credit, debit and prepaid cards as forms of payment and to define the “best” funding payment instruments for the transactions (U.S. Pat. App. 2011/0320345, eBay™), they fall short in that they are closed loop implementations requiring the same payment processing entity to maintain a relationship to both the merchant account and cardholder wallet thus limiting access and acceptance, and lack the ability to securely store non-payment instrument items.

Regardless of the wallet implementations and their processing methods, the customer needs a single, consistent and secure mechanism for populating and interacting with them to affect commerce.

By way of further background, Wells Fargo™ (U.S. Pat. No. 8,327,450) and IBM™ (U.S. Pat. No. 7,587,366) provide for methods and systems that address secure data storage. However, neither of these implementations addresses the need of a convenient, centralized view and management of a consumer's financial accounts for affecting commerce.

Also, American Express has implemented a “Private Payment” service where a user obtains a pseudo card number with a limited life to use for a web purchase so that no one ever sees an individual's real card number. U.S. Pat. App. 2009/0171852 provides a method for secure processing of electronic transactions using a “transaction code” in lieu of actual payment instruments. U.S. Pat. App. 2012/0259781 provides systems and methods for conducting payment transactions between a payer and a payee without divulging the payer-selected funding source or account to the payee. While these provide a level of payment instrument security, they lack integration into a single consumer vault with a centralized view and management of a consumer's financial accounts inherent in the present invention.

Further, American Express (U.S. Pat. No. 8,412,631) provides for a comprehensive, cloud based platform for processing financial transactions with an application programming interface so that application developers can take advantage of the framework provided therein. The American Express invention fails to consider the need and advantage of integrating financial payments with other important instruments and documents, and the need and advantage of providing a system and method for centralized consumer payment instrument and financial management.

Using the system and method of the present invention solves the foregoing disadvantages and others inherent in the prior art. Other advantages and features of the present invention will become apparent upon reading the following disclosure.

### SUMMARY OF THE INVENTION

A system and a method is provided for secure storage of consumers' financial accounts such as credit cards, debit cards, prepaid cards, checking accounts, savings accounts, proprietary gift cards, line of credit accounts, brokerage accounts, loyalty accounts, flexible spending accounts, health savings accounts, or the like, and storage of consumers' financial, legal or other important documents in an integrative vault providing payment processing access, protection, management, control and auditability over all of the consumers' payment instruments, other instruments, and important documents.

Further, the integrative vault enables integration of all the consumer's financial account transactions across all payment channels into a singular application. This provides the consumer with a centralized view of all of his/her financial accounts enabling him/her to conveniently manage and control his/her financial assets, and providing for their secure use in commerce. This centralized view enables a consumer to better budget and set financial goals.

While the embodiments described herein are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not to be limiting. Furthermore, the elements and features of the embodiments described herein are not exclusive to any embodiment. The elements and features described below can be used in any of the embodiments.

The present invention in one preferred embodiment contemplates a method for facilitating an electronic payment transaction request using an integrative vault system employing at least one server computer, the method including receiving and storing, by the at least one server computer of the integrative vault system, vault profile details and authentication credentials of a consumer; receiving and storing, by the at least one server computer of the integrative vault system, data relating to a plurality of payment instruments associated with the consumer; receiving and storing, by the at least one server computer of the integrative vault system, a payment determination strategy for the consumer for the plurality of payment instruments associated with the consumer; receiving and storing, by the at least one server computer of the integrative vault system, data associated with at least one designated payment credential requestor; receiving, by the at least one server computer of the integrative vault system, a payment credential request for the consumer including at least a portion of the authentication credentials of the consumer from the at least one designated payment credential requestor; authenticating, by the at least one server computer of the integrative vault system, the at least a portion of the authentication credentials of the consumer; determining, by the at least one server computer of the integrative vault system, one of the plurality of payment instruments associated with the consumer to use for the payment credential request based on the payment determination strategy for the consumer; obtaining, by the at least one server computer of the integrative vault system, at least one payment credential for the one of the plurality of payment instruments associated with the consumer; and providing, by the at least one server computer of the integrative vault system, the at least one payment credential to the at least one designated payment credential requestor to initiate the electronic payment transaction request into a payment network.

The present invention in another preferred embodiment contemplates a method for facilitating an electronic payment transaction request using an integrative vault system employing at least one server computer, the method including receiving and storing, by the at least one server computer of the integrative vault system, vault profile details and authentication credentials of a consumer; receiving and storing, by the at least one server computer of the integrative vault system, data relating to a plurality of payment instruments associated with the consumer; receiving and storing, by the at least one server computer of the integrative vault system, an indication of whether a specific payment instrument of the plurality of payment instruments or a payment determination strategy to determine one of the plurality of payment instruments is to be used for a token; receiving and storing, by the at least one server computer of the integrative vault system, data associated with at least one designated payment credential requestor; receiving, by the at least one server computer of the integrative vault system, a token mediation request from the at least one designated payment credential requestor, the token mediation request comprising the token and a portion of the authentication credentials of the consumer, the token including information pertaining to an issuer of the token; authenticating, by the at least one server computer of the integrative vault system, the portion of the authentication credentials of the consumer; if the specified payment instrument is to be used for the token received in the token mediation request, obtaining, by the at least one server computer of the integrative vault system, at least one payment credential corresponding to the specific payment instrument of the plurality of payment instruments; if the payment determination strategy is to be used for the token received in the token mediation request, obtaining, by the at least one server computer of the integrative vault system, at least one payment credential corresponding to the one of plurality of payment instruments determined by the payment determination strategy; and providing, by the at least one server computer of the integrative vault system, the at least one payment credential to the at least one designated payment credential requestor for initiation of the electronic payment transaction request into a payment network.

The present invention in yet another preferred embodiment contemplates a method for facilitating an electronic payment transaction request using an integrative vault system employing at least one server computer, the method including receiving and storing, by the at least one server computer of the integrative vault system, vault profile details and authentication credentials of a consumer; receiving and storing, by the at least one server computer of the integrative vault system, data relating to a plurality of payment instruments associated with the consumer; receiving and storing, by the at least one server computer of the integrative vault system, a payment determination strategy for the consumer for the plurality of payment instruments associated with the consumer; receiving and storing, by the at least one server computer of the integrative vault system, data associated with at least one merchant; receiving, by the at least one server computer of the integrative vault system, a consumer payment authorization request from the consumer, the consumer payment authorization request including at least a portion of the authentication credentials of the consumer, transactional and merchant details for the consumer payment authorization request, and one of an indication that a specified payment instrument and an indication that the payment determination strategy are to be used for the electronic payment transaction; authenticating, by the at least one server computer of the integrative vault system, the at least a portion of the authentication credentials of the consumer; if the indication that the specified payment instrument is to be used is received in the consumer payment authorization request, obtaining, by the at least one server computer of the integrative vault system, at least one payment credential corresponding to the specified payment instrument; if the indication that the payment instrument strategy is to be used is received in the consumer payment authorization request, obtaining, by the at least one server computer of the integrative vault system, at least one payment credential corresponding to a payment instrument determined by the payment instrument strategy; forwarding, by the at least one server computer of the integrative vault system, an authorization request including the at least one payment credential and the transactional details to an issuer of the at least one payment credential; receiving, by the at least one server computer of the integrative vault system, a decision on the authorization request from the issuer of the at least one payment credential approving or declining the authorization request; if the authorization request is approved by the issuer, forwarding, by the at least one server computer of the integrative vault system, an approved consumer authorization request into a payment network, the approved consumer authorization request being matched to a merchant payment authorization request to facilitate completion of the electronic payment transaction.

In one specific embodiment, within a service of an integrative vault 100 provided by his/her trusted financial institution, the consumer identifies the digital wallets or merchant websites or the like that he/she wants to allow access to which of his/her payment instruments. The consumer also identifies an intelligent payment instrument determination strategy, “Way to Pay”, for each of the identified websites or wallets (or providers thereof). A unique token is generated and provided to each website or wallet in lieu of payment credentials for traditional payment instruments. The token is a reversible, benign substitute for this sensitive data. The token may represent, be represented in, or augment bank account credentials such as bank routing number and account number, or the like; may represent, be represented in, or augment partial payment credentials such as card number, CVV2/CVC2, or the like; or, may represent, be represented in, or augment full payment credentials such as magnetic stripe data, EMV data, or the like. The token may be generated by the payment instrument issuer and/or by the integrative vault 100/integrative vault provider. It may be delivered to a digital wallet or website in the moment of the transaction for single use and have a limited life, or may be delivered in advance and updated after each use and/or on a periodic basis.

When the consumer (payer) initiates a payment authorization from one of his/her participating websites or wallets, the website, wallet or consumer's device provides its specific token in lieu of traditional payment instrument details for use in the authorization request. The authorization request, with the consumer's token, is transmitted from the merchant's (payee) POS device to the payment processor. Depending on the type of token (i.e., one that can be routed as-is through the payment networks, or one that requires lookup or mediation to translate the token into the actual payment credentials via the integrative vault 100/integrative vault provider), the payment processor either routes the request for authorization via the traditional payments network, or transmits the request to the consumer's integrative vault 100/integrative vault provider for payment instrument mediation and possible authorization. In the latter case, once the integrative vault 100/integrative vault provider mediates the authorization request's token and the payment instrument is determined, the vault provider will attempt to satisfy the authorization request. If this is not operationally possible, meaning the integrative vault 100/integrative vault provider does not have access to the payment instrument issuer, the payment instrument details are returned to the payment processor, and the authorization request is processed via traditional payment networks.

In another specific embodiment involving an alternative digital wallet implementation where the merchant is never presented with payment instrument details, the consumer captures merchant and transaction details with his/her smartphone, selects the payment instrument, and transmits a consumer payment authorization request directly to his/her alternative wallet provider. Rather than the alternate wallet provider storing the actual payment instrument credentials, the payment instrument credentials or a routable, limited-life token are delivered to the alternative wallet provider in the moment of the transaction by the integrative vault 100/integrative vault provider. Concurrently, the merchant transmits his/her portion of the payment authorization request to his/her payment processor. The alternative wallet provider transmits an authorization request with transaction and payment instrument or token details received from the integrative vault 100/integrative vault provider to the payment instrument issuer via the traditional payments network. Upon approval from the payment instrument issuer, the payment processor then marries the consumer approved authorization request to the merchant's payment authorization request based on merchant and transaction details present in both requests. The payment processor notifies the merchant of the outcome of the authorization, and sends a response to the consumer confirming the overall authorization outcome.

It is understood that both the foregoing general description and the following detailed description are exemplary and explanatory only, and are not restrictive of the invention as claimed.

### BRIEF DESCRIPTION OF DRAWINGS

The invention will now be described, by way of example only, with reference to specific embodiments and to the accompanying drawings in which:

FIG. 1 is a block diagram that illustrates the integrative vault business function framework;

FIG. 2 is a schematic diagram that illustrates the use of the integrative vault in a digital wallet payment embodiment;

FIG. 3 is a schematic diagram that illustrates the use of the integrative vault in a merchant website payment embodiment;

FIG. 4 is a schematic diagram that illustrates the use of the integrative vault in an alternative digital wallet payment embodiment;

FIG. 5 is a schematic diagram that illustrates the use of the integrative vault in an alternative merchant website payment embodiment;

FIG. 6 is a flow diagram that illustrates the overview of integrative vault payment process;

FIG. 7 is a flow diagram that illustrates the consumer vault registration process;

FIG. 8 is a flow diagram that illustrates the remote consumer payment instrument registration process;

FIG. 9 is a flow diagram that illustrates the consumer document registration process;

FIG. 10 is a flow diagram that illustrates the remote consumer digital wallet or merchant website registration process;

FIG. 11 is a flow diagram that illustrates the consumer vault deactivation process;

FIG. 12 is a flow diagram that illustrates the consumer digital wallet or merchant website deactivation process;

FIG. 13 is a flow diagram that illustrates the token mediation request process;

FIG. 14 is a flow diagram that illustrates the token mediation request with payment authorization process;

FIG. 15 is a flow diagram that illustrates the alternative digital wallet payment authorization process; and

FIG. 16 is a flow diagram that illustrates the payment authorization request process.

### DETAILED DESCRIPTION OF THE INVENTION

The present invention is now described with reference to drawings. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. While the embodiments described herein are described in sufficient detail to enable those skilled in the art to practice the disclosure, the detailed description herein is presented for purposes of illustration only and not of limitation.

The terms “first”, “second”, and the like, herein do not denote quantity or importance, but rather are used to distinguish one element from another. Further, a number of terms are used herein for convenience and ease of exposition.

An “access device” 200 is used to describe, for example, any device capable of wireless network communication and/or Internet connectivity. This may include, for example, a smartphone or Blackberry 210; personal computer 220; tablet or pad 230; laptop, notebook or netbook 240; personal digital assistant (PDA) 250; glasses 260, watches 270, or other wearable, affixable, ingestible, or otherwise useable devices, and also ATMs, teller systems, interactive voice response systems (IVR) and the like.

“Account aggregator service provider” 310 is used to describe, for example, an entity that compiles information from different accounts such as bank accounts, credit card accounts, investment or brokerage accounts, and other consumer or business accounts into a single source.

“Authentication” is used to describe, for example, the process of determining whether someone or something is, in fact, who or what it is declared to be. Specific to the preferred embodiment, authentication is used to establish the identity of a consumer of the integrative vault 100 to either permit user access to the vault or to permit payment processing using payment instruments securely stored in his/her vault. Most any authentication mechanisms, including third party inventions, can be employed in accordance with aspects of the innovation. Examples of mechanisms include user id/password; mobile telephone number, email address, or the like/password; token/PIN; token/card verification code or value; challenge/response; access device unique identifier; browser fingerprint and packet signature; geo-location; fingerprints; retinal patterns; facial recognition; signature/handwriting analysis; voice recognition; or the like. These mechanisms can be employed in singular or in combination for multiple factor tests in authenticating the identity of a consumer. Authentication may also be used to determine administrator, customer service representative, and developer identity, and whether to permit access to environments of the integrative vault 100.

“Biller or biller consolidator provider” 380 is used to describe, for example, an entity that presents its bills to its consumers, or a service provider that consolidates bills from multiple billers or other bill service providers to present to their consumers.

“Consumer” is used to describe, for example, a person or business that purchases goods or services or obtains cash advances. “Consumer” can also be used to describe a user of the integrative vault 100 regardless of whether the vault service offering is purchased.

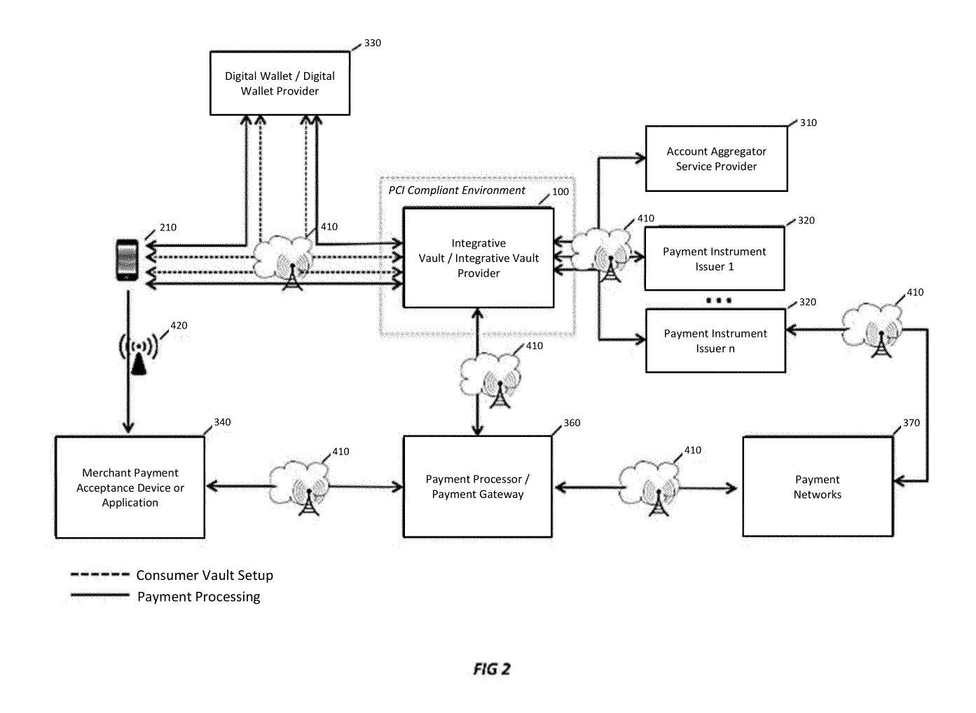

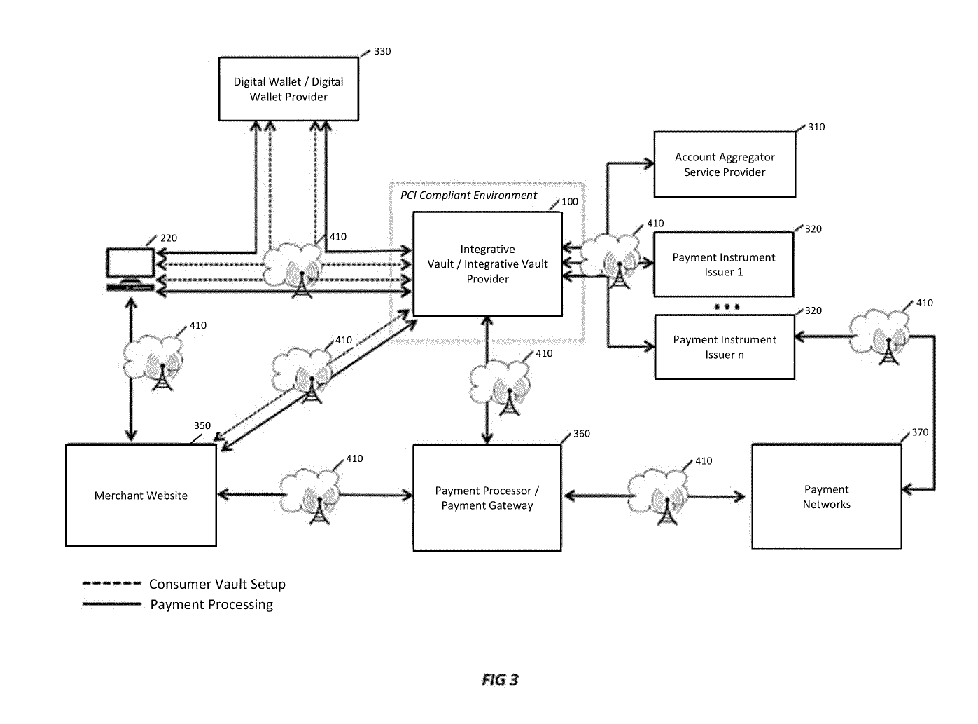

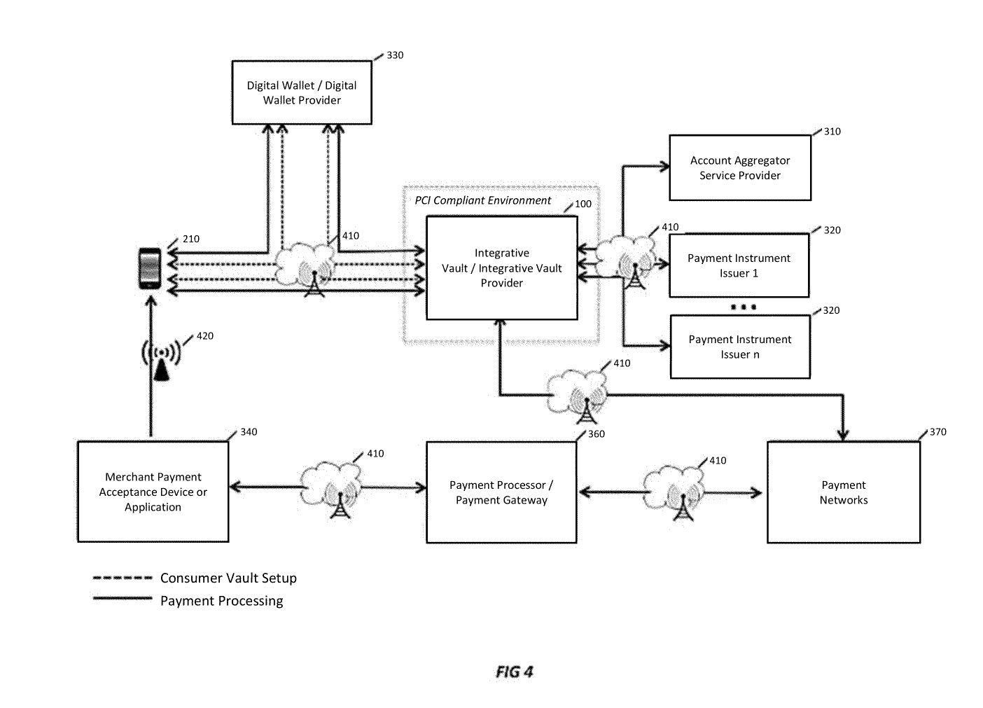

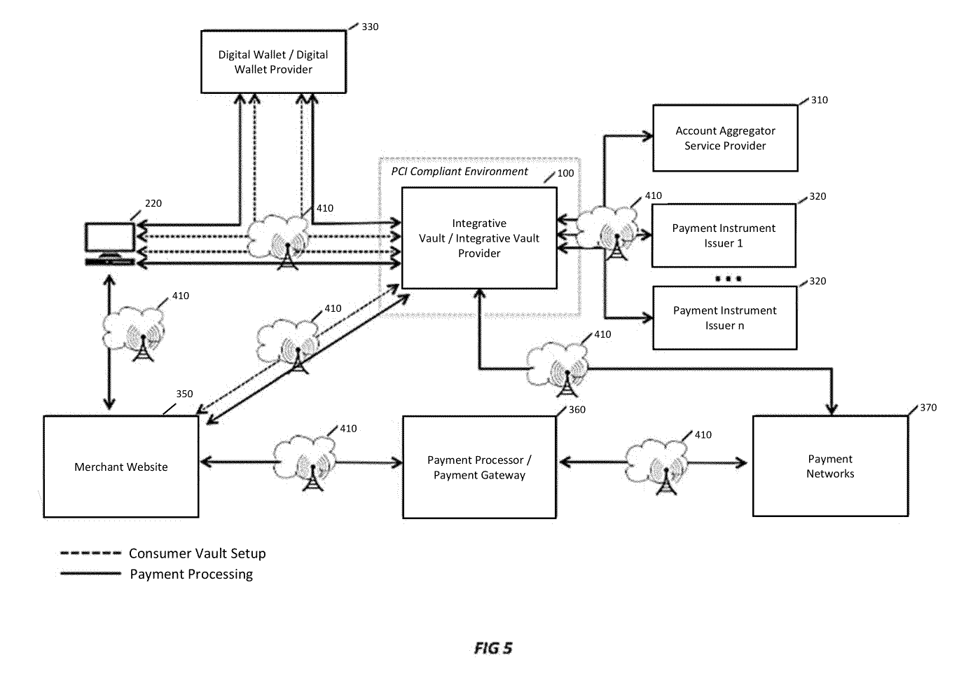

“Digital wallet” is used to describe, for example, at least for financial purposes, a payment (native or web based) application that allows consumers to digitally store and manage their credit, debit, prepaid gift or loyalty cards instead of carrying around a stack of physical plastic cards. The digital wallet can be provided on and/or accessed from the access device 200. For example, although the digital wallet is depicted as being separate from the smartphone 210 in FIGS. 2 and 4 and separate from the personal computer 220 in FIGS. 3 and 5, the digital wallet could be provided on the smartphone 210 and personal computer 220. Furthermore, rather being provided on the access devices 200, the digital wallet could be accessed from the access devices 200 via, for example, a telecommunications data network 410. The digital wallet may be used to initiate payment for goods and services or cash advances. The digital wallet may also facilitate other features, such as offers, coupons, loyalty rewards, electronic or digitized receipts, product information, identification, membership, and the like. “Digital Wallet Provider” 330 is used to describe the entity that issues, manages and services the digital wallet for the consumer. Generally speaking, reference to features and functions of the digital wallet, digital wallet provider 330, and digital wallet/digital wallet provider 330 refers to functionality that can be implemented by the digital wallet itself, digital wallet provider 330, and/or other third party providers.

“Important document” is used to describe any document or data, in digital form, that is of importance to a consumer. Examples include digital copies or versions of deeds; titles; insurance papers; loan and mortgage papers; banking documents; tax documents; wills; birth, adoption, marriage, bankruptcy, divorce, death and graduation/professional certificates; photographs or other digital images; household, safety deposit box, prescription drug usage and other such inventories; medical records; receipts; documents with sentimental value; or the like. A document may be linked or otherwise associated with other items in a consumer's vault. Documents may also be organized into folders to group similar documents or categorize documents within the vault. Documents may be placed in the integrative vault, read, retrieved, sent to third parties, or removed by the consumer.

“Internal/external entities” 300 is used to describe, for example, any internal/external entity that the integrative vault 100/integrative vault provider may need to communicate with in order to establish, augment or maintain vault items or item details and/or process payment or non-payment transactions. Examples of internal/external entities include account aggregator providers 310, payment instrument issuers 320, digital wallets/digital wallet providers 330, merchant devices or applications 340, merchant websites 350/merchant website providers, payment processors 360, payment networks 370, billers or biller consolidator providers 380, and also personal finance management providers, loan agencies, social media providers, money transmit, real or virtual currency exchanges, credit score agencies, Automated Clearing House (ACH), insurance providers, medical facilities, utilities and other service providers; local, state, federal and quasi governmental agencies and the like.

“Mediation” is used to describe the process of reconciling a payment instrument token with the actual payment instrument details based on the token embedded in a payment authorization message.

“Merchant” is used to describe a person or business, or aggregator as in the case of a merchant aggregator that sells goods, services or provides cash advances to consumers at a brick and mortar or any physical location, online, or via mail or telephone.

“Merchant payment acceptance device or application” 340 is used to describe the hardware or software application or combination thereof, where a payment transaction is initiated and completed. It is the point at which a consumer makes a payment to a merchant in exchange for goods, services or cash advance. Examples include point-of-sale (POS) devices, electronic funds transfer at point-of-sale (EFTPOS) terminals, electronic cash registers (ECR), POS enabled tablets or smartphones, payment portal (such as a website, mobile phone or IVR service), or the like.

“Merchant website” 350 is used to describe a merchant's or merchant aggregator's online commerce site allowing the consumer to purchase and pay for goods or services typically via a payment acceptance portal. For example, the payment acceptance portal can be provided by the shopping cart of the merchant website 350. In many cases, the consumer is given the option to store his/her payment instrument and other personal identifying details for future use. Examples include Amazon.com™, Walmart.com™, eBay.com™, BestBuy.com™, or the like. The merchant websites 350 can be implemented by the merchants, merchant aggregators, and/or other third party providers. Generally speaking, reference to the merchant websites 350 and features and functions thereof also refers to the merchants, merchant aggregators, and/or other third party providers, and functionality that can be implemented by the merchant websites 350, merchants, merchant aggregators, and/or other third party providers.

The “mobile device communication” 420 is dependent on the capabilities of access device 200 with the digital wallet provided thereon and the merchant payment acceptance device or application 340 and its technical details are outside the scope of this invention. However, it is noted that different types of communication can be used to communicate between the access device 200 with the digital wallet provided thereon and the merchant payment acceptance device or application 340. Exemplary methods include near field communication (NFC), radio-frequency identification (RFID), Bluetooth™ and Bluetooth Low Energy, ultrasound sound waves, scanning, reading, or otherwise capturing of barcodes (single-dimensional or matrix), and the like.

“Other instrument” is used to describe, for example, a card, account, or other item not typically used for paying for goods and services but has value or may be used as identification or to signify membership, subscription, or coverage in clubs, programs, insurance plans, or the like. Examples include mortgage or loan accounts; certificates of deposits (CD), individual retirement accounts (IRA), 401 k, 403 b, 529 educational, or the like accounts; government issued IDs and drivers licenses; coupons and offers; event, airline, train and bus tickets; transit passes; warehouse club, zoo, museum, AARP™ AAA™ memberships; prescription discount program memberships; health, auto, home/renters, flood insurance coverage, or the like.

“Payee” typically describes the merchant's role in a payment transaction, and may be used interchangeably with “merchant”. In some embodiments of this invention, however, “payee” may not be a merchant, but rather the recipient of a payment such as in the case of a person-to-person payment.

“Payer” typically describes the consumer's role in a payment transaction, and may be used interchangeably with “consumer”. In some embodiments of this invention, however, “payer” may be a business such as in the cases of business-to-consumer payments and business-to-business payments.

“Payment” can be described, for example, as the transfer of value from payer to payee in exchange for goods, services or cash advances. The transfer may be of monetary value, loyalty points, non-monetary value and/or the like, as agreed acceptable by both parties. The payment may be a one-time or recurring event.

“Payment credentials” describes the data associated with payment instrument required to initiate a payment transaction. The data may be the actual card or account details, or may be represented by a token.

“Payment credentials requestor” describes an entity that requests a consumer's payment instrument credential(s) from his/her integrative vault 100/integrative vault provider to enable the initiation of a payment transaction. Examples include the merchant website 350, digital wallet/digital wallet provider 330, and payment industry participants/entities along the chain of the transaction or the like requesting a consumer's payment instrument credential(s).

“Payment instrument”, in accordance with aspects of the innovation, is used to describe a method of paying for goods and services, which does not involve the exchange of cash. Examples include credit cards, debit cards, prepaid cards, checking accounts, savings accounts, proprietary gift cards, line of credit accounts, brokerage accounts, loyalty accounts, flexible spending accounts, health saving accounts, or the like.

“Payment instrument issuer” 320 is used to describe a financial institution or other entity that issues payment instruments, extends credit or holds funds, loyalty points or rewards, or the like for the consumer. The issuer manages the payment instrument account, provides customer service, and settles transactions against the account with other payment network entities. May also be referred to as simply “issuer”. A payment instrument issuer 320 may also be a provider of the service of the integrative vault 100.

“Payment network” 370 is used to describe a network of payment instrument issuers and acquirers that process payments. Examples include credit card networks such as those operated by Visa, MasterCard, American Express, Discover; debit card networks such as those operated by Visa, MasterCard, NYCE™, PULSE™, Interac™; private label processing networks; electronic funds transfer networks; automated clearing house networks; or the like.

“Payment processor/payment gateway” 360 is a company or companies (often third parties) appointed by a merchant to handle credit card transactions for the merchant. They have connections to various payment networks and supply authorization and settlement services to the merchant. Examples include FIRST DATA™, TSYS™, Heartland Payment Systems™, and the like.

“Telecommunications data network” 410 is a term used to describe the various wired or wireless connected networks that allow users seamless access to resources that are hosted outside of the particular provider to which they are connected. Telecommunications data network is meant in a broad sense, and may include any suitable technology for information transmission, including electrical, electromagnetic and optical technologies. Examples of telecommunication data networks include the Internet, intranets, wide area networks (WAN), metropolitan area networks (MAN), local area networks (LAN), campus area networks (CAN), virtual private networks (VPN), and digital cellular data networks, including: global system for mobile communications (GSM), general packet radio service (GPRS), cdmaOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN).

“Token” is a term used to describe a reversible, benign substitute for sensitive data. In accordance with aspects of the preferred embodiment, the token may represent, be represented in, or augment bank account credentials such as bank routing number and account number, or the like; may represent, be represented in, or augment partial payment credentials such as card number, card verification code, CVV2/CVC2, or the like; or, may represent, be represented in, or augment full payment credentials such as magnetic stripe data, EMV data, or the like. Furthermore, the token can include the consumer's authentication credentials for the integrative vault 100/integrative vault provider such as a password and/or PIN, or the like.

### Embodiments

Embodiments of the present invention relate to systems, methods, processes, computer readable medium, and means for an integrative vault 100 providing payment processing access, protection, convenience, management, control and auditability over all of the consumers' payment instruments, other instruments, and important documents. An embodiment may be implemented by a system, method, process, computer readable medium, and means, or any combination thereof. As discussed below, the present invention allows a plurality of consumers to register their information with the integrative vault 100/integrative vault provider to provision a respective consumer's vault. Transactions are then facilitated on behalf of the consumer using the information associated with his/her vault.

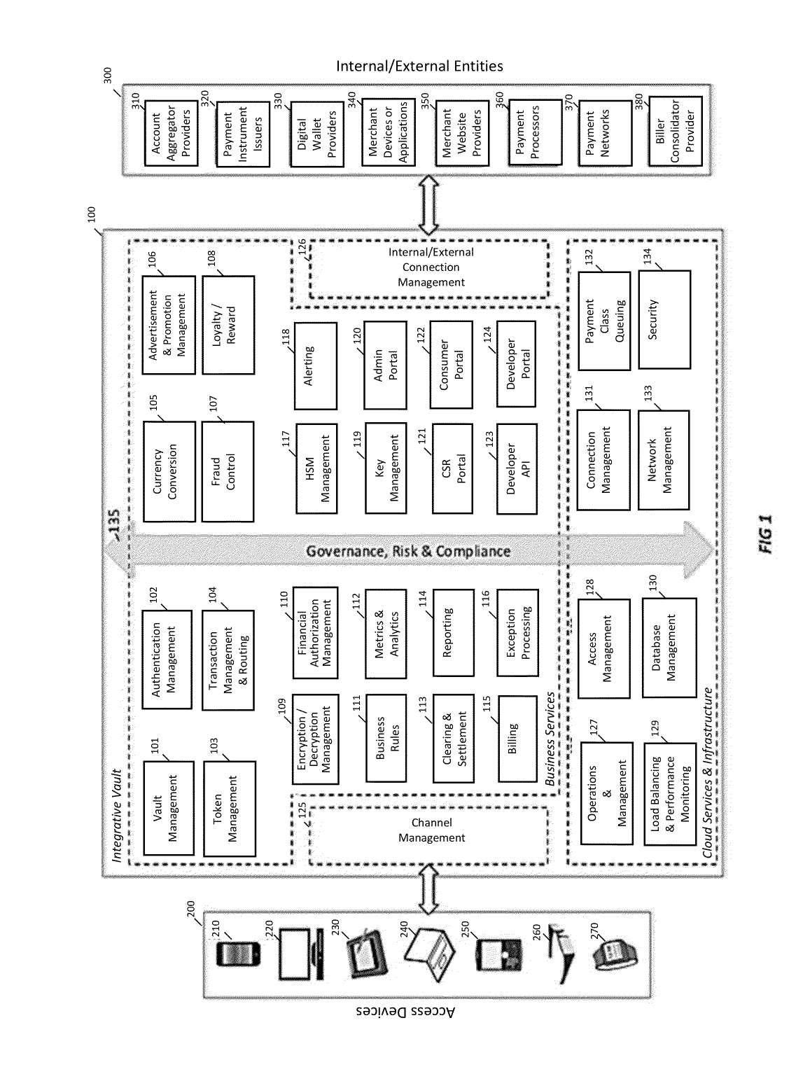

Referring initially to the drawings, FIG. 1 is a block diagram illustrating the business function framework contemplated for the integrative vault 100 in accordance with aspects of the innovation. The integrative vault 100 system and modules therein are provided for illustrative purposes only, and represent one possible implementation of a system pursuant to the present invention. Those skilled in the art will appreciate, upon reading this disclosure, that other implementations may also be used. The integrative vault 100 includes a number of modules or components that, together, provide the functions of the integrative vault 100 to support the processing of payment transactions pursuant to some embodiments. The integrative vault 100 may be deployed, for example, on one or more server systems. Furthermore, the features and functions described in association with the integrative vault 100 can performed by the service of the integrative vault 100 itself or can be performed by the integrative vault provider or third party providers. In other words, the functionality of the integrative vault 100 can be implemented by the integrative vault 100 itself or can be implemented by the integrative vault provider or third party providers. For example, the integrative vault 100 does not have to be self contained—the modules or components of the integrative vault 100 can be handled elsewhere by the integrative vault provider or third party providers. Generally speaking, reference to features and functions of the integrative vault 100, integrative vault provider, and integrative vault 100/integrative vault provider refers to functionality that can be implemented by the integrative vault 100 itself, integrative vault provider, and/or third party providers. Those skilled in the art will appreciate that this illustrative framework is just one example of an implementation, and that a number of design and configuration alternatives may be provided to achieve the functionality of the present invention.

FIG. 1 illustrates a system that enables an integrative vault 100 in accordance with aspects of the innovation. The integrative vault 100 provides storage of data/information representing consumers' financial accounts such as, for example, credit cards, debit cards, prepaid cards, checking accounts, savings accounts, proprietary gift cards, line of credit accounts, brokerage accounts, loyalty accounts, flexible spending accounts, health savings accounts, or the like; storage of consumers' financial, legal or other important documents; and, storage of data/information regarding profile details, authentication credentials, payment strategy and other related information. Such profile details of the consumer can be used by the service of the integrative vault 100, and such data/information can be stored in a database of the integrative vault 100 that is housed in a secure, industry compliant location. It is noted that the database can be one or more databases associated with the integrative vault 100/integrative vault provider. The integrative vault 100/integrative vault provider provides payment processing access, protection, convenience, management, control and auditability over all of the consumers' payment instruments and financial, legal or other important documents.

The integrative vault 100 is a secure consumer payment control system that enables integration of all the consumer's financial account transactions across payment channels including POS, mobile, Internet, ATM, teller, bill pay and the like into a singular application. This provides the consumer with a centralized view of all of his/her financial accounts enabling him/her to conveniently manage and control his/her financial assets. This centralized view enables a consumer to better budget and set financial goals.

It will be appreciated that financial institutions are the most likely party to be the providers of the service of the integrative vault 100, as they maintain the demand deposit accounts that are accessed to fund most payments. Consumers and businesses trust such third parties with their money, and they are highly regulated and supervised at federal and state levels. Third party control, however, is not limited to a financial institution. Further, it will be appreciated that the integrative vault 100 may be housed in a multi-tenant environment, where multiple third parties have control over their own services of the integrative vault 100.

Embodiments of the system are believed to provide exemplary benefits from a security perspective, as the chance for fraud is reduced since the consumer's actual payment instrument details are provided to neither a digital wallet/digital wallet provider 330 nor a merchant device or application 340. In some embodiments, the payment instrument details may not need to be provided to the payment processor 360 or any entity in the payment network 370 outside the payment instrument issuer 320. Other desirable advantages are from a consumer payment instrument management perspective, particularly when payment instrument details should be updated. In existing systems, the consumer should remember all his/her registered sites and/or wallets associated with the payment instrument, and should update each applicable site or wallet in order to initiate future transactions. The present invention provides for the convenient centralized control and management of all payment instruments within his/her vault.

As shown in FIG. 1, the integrative vault 100 includes of a core set of business services and a core set of infrastructure services interacting in an industry compliant environment to achieve the contemplated functionality. It will be appreciated that the integrative vault 100 functionality may be resident in a single private, community or public cloud, on-premise, or may be implemented in a hybrid cloud environment in which some functionality is resident in a third party's private, community or public cloud or on-premise with the remaining functionality resident in one or more private, community or public clouds, or on-premise. The same functionality, in the way of business and infrastructure services, that is required to offer the service of the integrative vault 100, may be leveraged and reused by the tenants to develop their own custom applications and move legacy application functionality to the integrative vault 100.

Furthermore, it will be appreciated that the environment of the integrative vault 100 provides on-demand scalability to handle peak consumer or transactional volumes or other sporadic, high load processing needs. It is highly secure and addresses the governance, risk and compliance needs of its tenants as it pertains to the functionality of the invention.

Pursuant to the functionality detailed in FIG. 1, a high level description is presented. Those skilled in the art will appreciate that the functionality of the invention may be deployed in a number of alternative configurations including those that include the described business functionality in its entirety or in partiality. It will also be appreciated that some or all of the functionality may be provided through third party vendors, providers or aggregators.

Vault management 101 is responsible for enabling the provisioning, management, and payment and non-payment processing associated with the elements of a consumer's integrative vault 100. This includes the addition and maintenance of vault entries, entry verification, entry annotation, entry linkage to other vault entries, management of digital wallets and merchant websites and definition of associated “Way to Pay” strategies, identification of biller or biller consolidator providers 380 and establishment of payments to these billers, establishment of budgetary and financial goals, and the like.

Authentication management 102 is used to determine whether someone or something is, in fact, who or what it is purported to be. Specific to this invention, authentication is used to establish the identity of the consumer of the integrative vault 100 to either permit user access to the vault, to permit payment processing using payment instruments securely stored in his/her vault, or to permit processing of other instruments and important documents securely stored in his/her vault. Authentication may also be used to determine administrator, customer service representative, and developer identity and whether to permit access to the environment of the integrative vault 100.

Token management 103 may generate, manage, monitor and automate the usage and ongoing maintenance of reversible, benign substitutes for data. In accordance with aspects of the preferred embodiment, the token may represent, be represented in, or augment bank account credentials such as bank routing number and account number, or the like; may represent, be represented in, or augment partial payment credentials such as card number, CVV2/CVC2, or the like; or, may represent, be represented in, or augment full payment credentials such as magnetic stripe data, EMV data, or the like. A Token Manager must ensure uniqueness of tokens across integrative vault providers and over a specified period of time.

Transaction management and routing 104 is used within the integrative vault 100 to transport payment and other transaction requests and responses across access channels and third parties to authorization destinations such as account aggregators 310, payment instrument issuers 320, payment processors 360, or payment networks 370 and the like in a completely secure manner.

Currency conversion 105 converts one monetary value, loyalty points, non-monetary value currency and the like, to another monetary value, loyalty points, non-monetary value currency and the like. While this allows customers to initiate payments in a first currency against a payment instrument in a second currency, it also allows consumers to convert monetary and non-monetary values to/from other monetary or non-monetary values assuming exchange rates can be established. For example, a consumer may convert his/her airline miles into US dollars or vice versa, assuming the airline mileage program permits the conversion and a conversion rate can be established. The integrative vault 100/integrative vault provider may interface with an external dynamic currency conversion (DCC) provider to obtain real-time currency rates.

Advertisement and promotion management 106 manages targeted offers and incentives to consumers of the integrative vault 100 based on the consumer details such as preferences, payment instruments, usage, transactional history, and the like. Integrative vault providers use this functionality as a means to incentivize specific consumer behavior or to promote additional products or services.

Fraud control 107 automates transaction fraud scoring, risk classification, screening, manual review, authorization disposition (accept/reject decisions), and fraud claim management. Fraud control may trigger an alert to a consumer with regard to suspicious activity or potential risk of fraud, and the consumer may be asked to verify the authenticity of the payment transaction prior to its ultimate approval.

Loyalty/reward 108 manages the accumulation and redemption or donation of reward points based on consumer usage or behavior within the integrative vault 100. Integrative vault providers use this functionality as a means to strengthen relationships with their consumers.

Encryption/decryption management 109 manages the process of encoding vault entries such as data/information representing payment instruments, other instruments, and legal or other important documents and the like in such a way that unauthorized users or hackers cannot read it, but authorized parties can. The vault entries are encrypted using an encryption algorithm, turning it into an unreadable ciphertext. Conversely, when access is required by an authorized party, the ciphertext is decrypted using a decryption algorithm.

Financial authorization management 110 enables the integrative vault 100/integrative vault provider to authorize payment and other transactions in some embodiments of the invention. Sufficient payment instrument details such as balance or available funds may be maintained on the integrative vault 100 to affect authorization if this service is enabled. Other details such as amount, merchant, geo/location, usage limits and the like may be considered in the authorization.

Business rules 111 provide integrative vault providers with a simplified mechanism to modify transaction management & routing 104 and financial authorization management 110 processing rules to suit their business and transactional processing needs.

Metrics and analysis 112 assists in the gathering, storing, analyzing, and access of data associated with the integrative vault 100 to help providers gauge some quantifiable component of their performance, such as uptake of new products or services or customer churn rate, and make better business decisions.

Clearing and settlement 113 supports the generation and/or the processing of the necessary interchange clearing information that the acquirer provides the appropriate issuer regarding monetary transactions, and affecting the exchange of funds between the parties for settlement.

Reporting 114 allows for the design, processing, and printing of reports pertaining to a range of consumer activity, integrative vault 100 activity, audit, policy compliance and security events.

Billing 115 allows for billing of consumers by integrative vault providers for usage of their vault service, or for billing of integrative vault providers for their use of the integrative vault 100.

Exception processing 116 supports the retrieval, chargeback, arbitration and compliance processes associated with the disputes between consumers and merchants or other entities

HSM management 117 provides an interface to hardware security modules (HSMs) used for performing secure cryptographic processing. In the payment industry, encryption is commonly performed using a hardware appliance, however, a secure method of software encryption may also be employed.

Alerting 118 provides instant notification, via paging, emailing, calling or texting and the like, to consumers regarding transactions such as purchase or cash withdrawals; accounts such as credits or debits to an account, balance, term deposit maturity or card expiry; upcoming or overdue bill payments; and fraud protection and the like. Alerts may also be sent to consumers to notify them of available promotions or incentives, or to notify or to suggest use of a specific payment instrument given some contextual detail of the moment and/or of the consumer (e.g., consumer's location). The same alerting functionality may be used to notify integrative vault providers or system administrators of the states or events within the integrative vault 100.

Key management 119 controls management of keys, key holders, hardware locations, master key systems, overdue keys and maintenance service schedules and the like; and reports on this information.

Administration portal 120 is a secure access portal that provides the tools the administrators of the integrative vault 100 need to provision and manage all the elements in the system, while tracking performance, health and efficiency. Language-dependent portals may be exposed through a language-independent implementation.

Customer service representative (CSR) portal 121 is a secure integrative vault provider-facing access portal designed to provide managers and customer service representatives with the tools to support the service of the integrative vault 100 for their consumers. Language-dependent portals may be exposed through a language-independent implementation.

Consumer portal 122 is a secure consumer-facing portal designed to provide access to the integrative vault 100 so that the consumer may provision and manage all the elements of his/her integrative vault 100. Language-dependent portals may be exposed through a language-independent implementation.

Developer API toolkit 123 is a set of application development tools that supports a number of mobile or web technology platforms, and operating systems. Developers use these tools to address the complexity of their application as modular business services that can be easily integrated and reused, creating a truly flexible, adaptable IT infrastructure. This invention also contemplates a set of APIs that run on the various access devices to facilitate the interfacing of the devices to the integrative vault 100.

Developer portal 124 is a secure access portal designed for developer access to the developer toolkit and development sandbox to develop mobile apps, POS apps, banking applications, and the like. The developer toolkit and sandbox environment allows the integrative vault providers to use the “test and learn” approach to product development enabling rapid-fire introduction, modification and termination of new services. Language-dependent portals may be exposed through a language-independent implementation.

Channel manager 125 manages the communication and channel specific business logic layer for the various access devices. The integrative vault 100 may communicate through a number of channels such as a smartphone or Blackberry 210; personal computer 220; tablet or pad 230; laptop, notebook or netbook 240; personal digital assistant (PDA) 250; glasses 260, watches 270, or other wearable, affixable, ingestible, or otherwise useable devices, and also ATMs, teller systems, interactive voice response systems (IVR) and the like.

Internal/external connection management 126 manages the communication and connection interface-specific business logic layer for the various entities with which the integrative vault 100/integrative vault provider interacts. Connection interfaces may be web services, XML, fixed, ISO 8583 based or the like. The integrative vault 100/integrative vault provider may interface with third parties such as account aggregation providers 310, payment instrument issuers 320, digital wallets/digital wallet providers 330, merchant devices or applications 340, merchant websites 350/merchant website providers, payment processors 360, payment networks 370, biller or biller consolidator providers 380, and also loan agencies, social media providers, real or virtual currency exchanges, credit score agencies, automated clearing houses, insurance providers, medical facilities, utilities and other service providers; local, state, federal and quasi governmental agencies and the like.

Operations & management 127 provides operations dashboards to give deep insights and visibility into health, risk and efficiency of the cloud or on-premise infrastructure, performance management and capacity optimization capabilities.

Access management 128 provides role-based access control of privileges within or across the integrative vault 100 ensuring compliance with business policies. It provides requisite audit reporting.

Load balancing & performance monitoring 129 monitors the health and performance of individual servers in real time. It automatically routes incoming traffic to efficiently utilize application servers across a variety of potential workloads and applications.

Database management 130 allows the definition, creation, querying, update, and administration of databases and interaction with users, applications and the data itself. Examples of database management system may be SQL based, NoSQL based or the like, and capable of handling both large amounts of transactional data and encrypted documents.

Connection management 131 provides administrators with the ability to create and maintain customized remote access connections.

Payment class queuing 132 allows traffic to share bandwidth equally, after being grouped by classes. The classes can be based upon a variety of parameters, such as priority, connection interface, or originating application or service.

Network management 133 manages and monitors system components such as routers, switches, devices, connection interfaces and the like. It monitors the components to determine the health of the network and the extent to which their performance matches capacity plans and service-level agreements. Network performance analysis tracks performance indicators such as bandwidth utilization, packet loss, latency, availability and uptime, and alerts a network administrator to specific network scenarios.

Security 134 analyzes and identifies application, web application, mobile application, and network security risks by providing application and network security analysis to protect applications, data, and networks from hackers and other outside entity attacks.

Governance, risk, and compliance 135 provides a view of governance, risk and compliance activities through reports and dashboards which provide the users of the integrative vault 100 with the information needed to complete tasks and make informed decisions.

FIG. 2 is a depiction of an environment in which the present invention may be practiced. The environment includes the integrative vault 100 and a consumer using an access device 200, such as a smartphone 210, to access the integrative vault 100/integrative vault provider for data entry via a telecommunications data network 410. The integrative vault 100/integrative vault provider performs an authentication process based on data retrieved from the database of the integrative vault 100/integrative vault provider to confirm the identity of the consumer in order to permit access to his/her vault data. Once authenticated, the consumer may register his/her payment instruments, his/her digital wallets or desired merchant websites. He/she may also determine which digital wallets or merchant websites have access to which of his/her payment instruments. Further, the consumer can identify an intelligent payment instrument determination strategy, “Way to Pay”, for each of the identified websites or wallets (or providers thereof). Data specific to the registered payment instruments, digital wallets or desired merchant websites, and the intelligent payment instrument determination strategy is stored in the database of the integrative vault 100/integrative vault provider.

“Way to Pay” is a prioritization process whereby the consumer or integrative vault provider define a payment instrument selection strategy for use by the integrative vault 100/integrative vault provider during payment processing. The strategy, retrieved from the database of integrative vault 100/integrative vault provider, may be based on the integrative vault provider's or consumer's preferred payment instruments; transactional details such as transaction amount, merchant identifier, merchant category, merchant location, date, time of day, and the like; merchant details such as accepted payment instruments; payment instrument details such as balance, credits, open to buy, loyalty/rewards incentives and the like; consumer location, consumer transactional history, consumer activity such as counts and amounts of recent or previous payment activities; or any combination thereof. The strategy may be inclusive or exclusive with consideration to certain transactional or payment instrument details. For example, a strategy may dictate that a specific payment instrument such as Starbucks™'s gift card is to be used only at Starbuck's, or that a specific payment instrument cannot be used at merchants located outside of the state of Nebraska or for any authorization over $750.00. The latter, restrictive aspect of “Way to Pay” is an advantageous fraud prevention or consumer control feature of this present innovation. If the consumer provides no payment determination strategy, the integrative vault 100/integrative vault provider can provide a default payment determination strategy.

A unique token is then generated (e.g., by the payment instrument issuer and/or by the integrative vault 100/integrative vault provider) and provided to each website 350 or digital wallet/digital wallet provider 330, in the case of the present embodiment, in lieu of payment credentials from traditional payment instrument details. Depending on the constitution of the token, it may be stored in the database of the integrative vault 100/integrative vault provider for use in the token mediation process. The token may be delivered to the website 350 or digital wallet/digital wallet provider 330 in the moment of the transaction and have a limited life, or may delivered in advance and updated after each use and/or on a periodic basis such as in a recurring payments scenario. The token may correspond to a specific consumer payment instrument or may default to a payment instrument based on the consumer's defined “Way to Pay” prioritization strategy. Furthermore, the token can include the consumer's authentication credentials for the integrative vault 100/integrative vault provider such as a password and/or PIN, or the like.

When the consumer, the payer, initiates a payment authorization from one of his/her digital wallets, the digital wallet provided on or accessible from the access device 200 communicates the token and/or token details to a merchant, the payee, at a physical location using a merchant payment acceptance device or application 340 to accept a payment from the consumer. The token and/or token details can include, for example, an indication of the issuer of the token. The method of mobile device communication 420 is dependent on the capabilities of the access device 200, the digital wallet provided on or accessible from the access device 200, and the merchant's payment acceptance device or application 340 and is outside the scope of this invention.

The merchant payment acceptance device or application 340 embeds the token and/or token details and other consumer and transactional details (such as, for example, an access device identifier and merchant details, and the like) in an electronic payment authorization request. It then communicates this request to a payment processor/payment gateway 360 via a telecommunications data network 410 for authorization processing through a network of payment industry participants, such as a payment network 370, examples of such being Visa and MasterCard, and then to a payment instrument issuer 320, examples of such being financial institutions that issue credit or debit cards to consumers.

Pursuant to this embodiment and depending on the type of token (i.e., routable as-is, or requires mediation), the payment processor 360 either routes the request for authorization via the traditional payments network 370, or transmits the request to the consumer's integrative vault 100/integrative vault provider for payment instrument mediation and possible authorization. In the latter case, the payment processor 360 must first have the integrative vault 100/integrative vault provider mediate the token (i.e., reconcile token with the actual payment instrument details based on the token embedded in the payment authorization message) before forwarding the authorization request to the payment network 370.

For token mediation, upon receiving the payment authorization request from the merchant payment acceptance device or application 340, the payment processor 360 recognizes the token as non-standard payment instrument requiring mediating, then forwards the authorization request in the form of a token mediation request to the integrative vault 100/integrative vault provider via a telecommunications data network 410. As the integrative vault 100 may be implemented in a multi-tenant environment, the integrative vault 100 may forward on the request to the consumer's integrative vault provider.

Upon receiving the token mediation request, the consumer's integrative vault 100/integrative vault provider determines the payment instrument, wallet or merchant website associated with the token in the request based on data stored in the database of the integrative vault 100/integrative vault provider. The integrative vault 100/integrative vault provider then performs an authentication process to ascertain whether the payer initiating the payment is permitted access to the payment instruments stored in the consumer's vault. The authentication method may make use of data (e.g., one or more items of data) transmitted in the mediation request such as the consumer authentication credentials included with the token (e.g., a password and/or PIN), other credentials included with the token (e.g., card verification code and magnetic stripe data), access device identifier and the like to authenticate the payer.

Once the payer authentication is confirmed and if a specific payment instrument is not indicated by the token, the integrative vault 100/integrative vault provider uses the consumer's defined “Way to Pay” prioritization strategy as retrieved from the database of the integrative vault 100/integrative vault provider to select the payment instrument for use in payment processing. The strategy may be as basic as selecting the payment instrument defined as “top of wallet” or may be based on transactional details forwarded with the payment authorization request such as transaction amount, merchant identifier, merchant category, merchant location, date, time of day, and the like; payment instrument details such as balance, credits, open to buy, loyalty/rewards incentives and the like; consumer activity such as counts and amounts of recent or previous payment activities; or any combination thereof. The latter restrictive aspect of “Way to Pay” is an advantageous fraud prevention feature of this present innovation.

If the consumer's “Way to Pay” strategy has consideration for payment instrument balances, credits, open to buy, and the like, then the integrative vault 100/integrative vault provider generates a balance inquiry request and transmits it via a telecommunications data network 410 to the account aggregator provider 310 or appropriate payment instrument issuer 320 to obtain the needed data. The account aggregator provider 310 or payment instrument issuer 320 looks up the payment instrument balance and returns it in a response to the integrative vault 100/integrative vault provider. This request/response processing is completed for each needed balance.

An exemplary example of payment instrument selection is presented. Assume the consumer has three payment instruments defined for his/her digital wallet: a debit card associated with his/her checking account, a Visa credit card, and a MasterCard credit card. Further, the consumer prefers to use his/her checking account as the funding source for all payments less than $75.00 but does not want his/her balance to drop below $500.00, which will cause him additional banking service fees. Also, the consumer prefers to use his/her Visa credit card rather than his/her MasterCard credit card, as the Visa cards accumulates points towards airline awards, but has limited available credit. The MasterCard has sufficient available credit to cover most any of the consumer's desired payments. In this instance, the MasterCard card is set as the default payment instrument with no consideration to balance in the payment instrument selection process and is only used if no other payment instrument meets the “Way to Pay” criteria. Bear in mind that the “Way to Pay” strategy processing simply determines the payment instrument to use in the payment authorization request. At some point in payment processing flow, the payment instrument issuer will determine whether to authorize the payment authorization request.

Using the preceding example “Way to Pay” strategy, a mediation request for a payment authorization of $54.25 is received by the integrative vault 100/integrative vault provider. Once the payer is authenticated, the integrative vault 100/integrative vault provider uses the consumer's defined “Way to Pay” prioritization strategy to select the payment instrument for use in payment processing. As the checking account is the preferred payment instrument for payments less than $75.00, the integrative vault 100/integrative vault provider generates a balance inquiry request and transmits it to the account aggregator provider 310 or consumer's checking account payment instrument issuer 320. The account aggregator provider 310 or payment instrument issuer 320 looks up the payment instrument balance and returns it in a response to the integrative vault 100/integrative vault provider. If the balance is greater than $554.25, the checking account is selected as the payment instrument. If the balance is less, the integrative vault 100/integrative vault provider generates a balance or open to buy inquiry request and transmits it to the account aggregator provider 310 or consumer's Visa payment instrument issuer 320. The account aggregator provider 310 or payment instrument issuer 320 looks up the payment instrument balance or open to buy and returns it in a response to the integrative vault 100/integrative vault provider. If the available credit is at least $54.25, the Visa card is selected as the payment instrument. If not, the MasterCard card is selected as the payment instrument.

Once the authorization request's payment instrument is determined, the integrative vault 100/integrative vault provider will send the authorization request to the payment instrument issuer 320 if so configured, otherwise the payment instrument details (or payment instrument credentials) are returned to the payment processor 360. In doing so, the integrative vault 100/integrative vault provider can also make a determination whether certain payment credentials have been previously provided or need to be provided. Once the payment instrument credentials are returned to the payment processor 360, the integrative vault 100/integrative vault provider may inform the payment instrument issuer 320 of the consumer's request for payment credentials and the context in which the request was made such as consumer location, access device identifier, merchant identifier, merchant category, merchant location, date, time of day, and the like. The payment instrument issuer 320 may in turn use this information to inform its authorization or risk management systems of the consumer's intent to purchase.

Once the payment processor 360 has routable payment credentials, it determines the appropriate payment network 370 based on payment instrument details such as type or issuer, and transmits the authorization request to the appropriate payment network 370 via a telecommunications data network 410. The payment network 370 may authorize the request, or as in most cases, will forward the request to the payment instrument issuer 320 for authorization via a telecommunications data network 410. For digital wallets/digital wallet providers 330 that require tokens to be delivered in advance and pre-provisioned for future purchases, the integrative vault 100/integrative vault provider generates a new, unique token, and transmits the token to the digital wallet/digital wallet provider 330 via a telecommunications data network 410.

If the payment instrument issuer 320 receives a token rather than the actual payment instrument, the issuer must first determine the actual payment instrument before performing the authorization. The payment instrument issuer 320 authorizes the payment authorization request for the payment instrument using its own decision criteria, and then returns the authorization decision in an authorization response to the payment network 370. The payment network 370 returns the authorization response to the payment processor 360. The payment processor 360 returns the authorization response to the merchant payment acceptance device or application 340. The merchant acts on the payment authorization result either by completing the exchange of goods or services or advancing cash to the consumer for an approval, or by asking for an alternative means of payment for a decline.

The payment authorization is simply a means to ensure the payer has sufficient funds in the account associated with the payment instrument to cover the amount of the payment and the payment instrument issuer's commitment to hold the funds. Funds are not typically moved among the payment network entities until the merchant submits a settlement transaction for the authorized payment to the payment processor 360. The payment processor 360, or in many cases the merchant's bank, submits the settlement transaction to the payment network 370 who ultimately presents the settlement transaction to the payment instrument issuer 320. The payment instrument issuer 320 affects the payee's account based on the settlement transaction and settles the funds with the payment network 370, who settles with the payment processor 360, who settles with the merchant's bank, who finally transfers fund to the merchant's account to settle the payment. At this point, the payment transaction is completed.

FIG. 3 illustrates a similar embodiment to the one illustrated in FIG. 2 with the exception of the payment initiation environment. In this embodiment, as with the one illustrated in FIG. 2, the consumer has registered his/her payment instruments, digital wallets and merchant websites, and “Way to Pay” strategies. In the FIG. 3 embodiment, rather than the consumer being physically present at the merchant location and the payment transaction being initiated via the merchant payment acceptance device or application 340, the consumer is using an access device 200, such as a personal computer 220, to access the merchant website 350 to complete a payment for goods or services via a telecommunications data network 410.

With online commerce, the payer typically enters his/her payment card or bank account details into a payment acceptance portal provided by the merchant website's 350 shopping cart to initiate the payment authorization. In many cases, the payer is given the option to store his/her payment card or bank account details with the merchant for use in future transactions. Pursuant to this embodiment, the merchant website is registered within the consumer's integrative vault in advance of consumer commerce initiation. Upon checkout, the integrative vault 100/integrative vault provider is then used as the source for the payment token and other personal identifying consumer details. Upon delivery of payment token and other personal identity details to the digital wallet/digital wallet provider 330 or merchant website 350, the integrative vault 100/integrative vault provider may inform the payment instrument issuer 320 of the consumer's request for payment credentials and the context in which the request was made such as consumer location, access device identifier, merchant identifier, merchant category, merchant location, date, time of day, and the like.

The merchant website 350 or payment acceptance portal thereof embeds the token and/or token details, other consumer and transactional details (such as, for example, access device identifier and merchant details, and the like) in an electronic payment authorization request. It then communicates this request, via a telecommunications data network 410, to a payment processor/payment gateway 360 for authorizing processing through a network of payment industry participants. Pursuant to this embodiment and depending on the type of token (i.e., routable as-is, or first requires mediation), the payment processor 360 either routes the request for authorization via the traditional payments network 370, or transmits the request to the consumer's integrative vault 100/integrative vault provider via a mediation request for payment instrument mediation before forwarding on the authorization through the payment network 370. Once the payment processor/payment gateway 360 has routable payment credentials, the payment authorization request progresses through the remaining requisite network of payment industry participants as in FIG. 2.

FIG. 4 illustrates one embodiment involving an alternative digital wallet implementation where the merchant is never presented with consumer's payment instrument details. In this embodiment, the consumer registers his/her payment instruments for the alternative digital wallet. He/she may also determine which of his/her payment instruments have access to his/her digital wallet. Further, the consumer can identify an intelligent payment instrument determination strategy, “Way to Pay” for the digital wallet/digital wallet provider 330. No token is generated or exchanged with the digital wallet/digital wallet provider 330, though the provider may be used for vault setup and maintenance.

In this embodiment, the merchant payment acceptance device or application 340 is capable of communicating merchant and transaction details to the consumer's digital wallet provided on or accessible from the access device 200, such as a smartphone 210. The method of mobile device communication 420 is dependent on the capabilities of the access device, the digital wallet provided on or accessible from the access device 200, and the merchant's payment acceptance device or application 340, and is outside the scope of this invention.

The consumer captures merchant and transaction details with his/her access device 200, and transmits a consumer payment authorization request directly to his/her integrative vault 100/integrative vault provider via a telecommunications data network 410. The consumer payment authorization request may include consumer authentication credentials (e.g., a password and/or PIN), and other consumer and transactional details (such as, for example, card verification code, access device identifier and merchant details, and the like). The consumer may dictate the payment instrument to use in the authorization request. A payment instrument nickname or other generic identifier known to both the digital wallet and the consumer's integrative vault 100/integrative vault provider may be communicated in the consumer's payment authorization request. If no payment instrument is identified in the request, the digital wallet's “Way to Pay” strategy will be invoked to make the payment instrument determination. Concurrently, the merchant using his/her merchant payment acceptance device or application 340 transmits his/her portion of the payment authorization request (including merchant details such as, for example, merchant acquirer financial institution identifier) to his/her payment processor 360 via a telecommunications data network 410.

Upon receiving the consumer's payment authorization request, the consumer's integrative vault 100/integrative vault provider performs an authentication process to ascertain whether the payer initiating the payment is permitted access to the payment instruments stored in the consumer's vault. The authentication method may make use of data (e.g., one or more items of data) transmitted during the consumer payment authorization request such as the consumer authentication credentials (e.g., a password and/or PIN), other of the above-discussed consumer and transactional details such as credentials (e.g., card verification code), access device identifier, and merchant details, and the like to authenticate the payer.

Once the payer authentication is confirmed, the integrative vault 100/integrative vault provider either determines the payment instrument based on the payment instrument nickname provided in the consumer's payment authorization request, or lacking that, uses the consumer's defined “Way to Pay” prioritization strategy, defined for the digital wallet/digital wallet provider 330, to select the payment instrument for use in payment processing.

The strategy may be based on transactional details forwarded with the consumer payment authorization request such as transaction amount, merchant identifier, merchant category, merchant location, date, time of day, and the like; payment instrument details such as balance, credits, open to buy, loyalty/rewards incentives and the like; consumer activity such as counts and amounts of recent or previous payment activities; or any combination thereof. The latter restrictive aspect of “Way to Pay” is an advantageous fraud prevention feature of this present innovation.

Once the consumer's payment instrument is determined, the integrative vault 100/integrative vault provider generates an authorization request with consumer and transactional details (such as those discussed above and now possibly including details such as the payment instrument details), and then forwards it to the payment instrument issuer 320 for authorization via a telecommunications data network 410. The payment instrument issuer 320 authorizes the payment authorization request for the payment instrument using its own decision criteria. The payment instrument issuer 320 then returns the authorization decision in an authorization response to the integrative vault 100/integrative vault provider.

Upon receiving the authorization response from the payment instrument issuer 320, the integrative vault 100/integrative vault provider forwards a consumer approved authorization request to a traditional payment network 370 via a telecommunications data network 410. The payment network 370 routes the consumer approved authorization request, based on the merchant details such as a merchant acquirer financial institution identifier, to the merchant's payment processor 360 via a telecommunications data network 410. The payment processor 360 then marries the consumer approved authorization request to the merchant's payment authorization request based on merchant and transaction details present in both requests. The payment processor 360 returns the authorization response to the merchant payment acceptance device or application 340. The merchant acts on the payment authorization result either by completing the exchange of goods or services or advancing cash to the consumer for an approval, or by requesting an alternative means of payment for a decline. The payment processor also returns a response to the consumer approved authorization to the originating payment network 370, who in turns forwards the response to the integrative vault 100/integrative vault provider. The integrative vault 100/integrative vault provider may notify the consumer's access device 200 of the authorization outcome.

While the actual payment instrument details will be provided to the payment network 370 in this embodiment, it is at the discretion of the payment network 370 as to whether to forward on the complete payment instrument identifier, to partially mask it, or to provide a suitable, non-high value token as a substitute, thus limiting the propagation of the consumer payment instrument details across multiple payment network entities.

Also, while the authorization process illustrated in this embodiment requires changes to the traditional payment network 370 and payment processor 360 processing, it provides each entity with a completed authorization request to be used in its settlement and fund movement processing. As with the previous embodiments, the payment authorization is simply a means to ensure the payer has sufficient funds in the account associated with the payment instrument to cover the amount of the payment and the payment instrument issuer's commitment to hold the funds. Funds are not typically moved among the payment network entities until the merchant submits a settlement transaction for the authorized payment to the payment processor 360. The payment processor 360, or in many cases the merchant's bank, submits the settlement transaction to the payment network 370 who ultimately presents the settlement transaction to the payment instrument issuer 320. The payment instrument issuer 320 affects the payee's account based on the settlement transaction and settles the funds with the payment network 370, who settles with the payment processor 360, who settles with the merchant's bank, who finally transfers fund to the merchant's account to settle the payment. At this point, the payment transaction is completed.

FIG. 5 illustrates a similar embodiment of an alternative digital wallet implementation to the one illustrated in FIG. 4 with the exception of the payment initiation environment. In this embodiment, as with the one illustrated in FIG. 4, consumer registers his/her payment instruments for the alternative digital wallet. He/she may also determine which of his/her payment instruments have access to his/her digital wallet. Further, the consumer can identify an intelligent payment instrument determination strategy, “Way to Pay” for the digital wallet/digital wallet provider 330. No token is generated or exchanged with the digital wallet/digital wallet provider 330 or the merchant website 350. In this embodiment, rather than the consumer being physically present at the merchant location and the payment transaction being initiated via the merchant payment acceptance device or application 340, the consumer is using an access device 200, such as a personal computer 220, to access the merchant website 350 to complete a payment for goods or services via a telecommunications data network 410.

With online commerce, the payer typically enters his/her payment card or bank account details into a payment acceptance portal provided by the merchant website's 350 shopping cart to initiate the payment authorization. In many cases, the payer is given the option to store his/her payment card or bank account details with the merchant for use in future transactions. Pursuant to this embodiment, upon checkout, the integrative vault 100/integrative vault provider is then used as the source for the payment credentials and other personal identifying consumer details such as those included in the above-discussed token.

In this embodiment, the merchant website 350 is capable of interfacing with and transmitting consumer, merchant, and transaction details to the consumer's integrative vault 100/integrative vault provider via a telecommunications data network 410. The consumer payment authorization request may include consumer authentication credentials (e.g., a password and/or PIN), and other consumer and transactional details (such as, for example, card verification code, access device identifier and merchant details, and the like). The consumer may dictate the payment instrument to use in the authorization request. A payment instrument nickname or other generic identifier known to both the digital wallet and the consumer's integrative vault 100/integrative vault provider may be communicated in the consumer's payment authorization request. If no payment instrument is identified in the request, the digital wallet's “Way to Pay” strategy will be invoked to make the payment instrument determination. Concurrently, the merchant website 350 transmits the merchant portion of the payment authorization request (including merchant details such as, for example, merchant acquirer financial institution identifier) to his/her payment processor 360 via a telecommunications data network 410.

Upon receiving the consumer's payment authorization request, the consumer's integrative vault 100/integrative vault provider performs an authentication process to ascertain whether the payer initiating the payment is permitted access to the payment instruments stored in the consumer's vault. The authentication method may make use of data (e.g., one or more items of data) transmitted during the consumer payment authorization request such as the consumer authentication credentials (e.g., a password and/or PIN), other of the above-discussed consumer and transactional details such as credentials (e.g., card verification code), access device identifier, and merchant details, and the like to authenticate the payer.

Once the payer authentication is confirmed, the integrative vault 100/integrative vault provider either determines the payment instrument based on the payment instrument nickname provided in the consumer's payment authorization request, or lacking that, uses the consumer's defined “Way to Pay” prioritization strategy, defined for the digital wallet/digital wallet provider 330, to select the payment instrument for use in payment processing.

Once the consumer's payment instrument is determined, the integrative vault 100/integrative vault provider generates an authorization request with consumer and transactional details (such as those discussed above and now possibly including details such as the payment instrument details), and then forwards it to the payment instrument issuer 320 for authorization via a telecommunications data network 410. The payment instrument issuer 320 authorizes the payment authorization request for the payment instrument using its own decision criteria. The payment instrument issuer 320 then returns the authorization decision in an authorization response to the integrative vault 100/integrative vault provider.

Upon receiving the authorization response from the payment instrument issuer 320, the integrative vault 100/integrative vault provider forwards a consumer approved authorization request to a traditional payment network 370 via a telecommunications data network 410. The payment network 370 routes the consumer approved authorization request, based on the merchant's details such as a merchant acquirer financial institution identifier, to the merchant's payment processor 360 via a telecommunications data network 410. The payment processor 360 then marries the consumer approved authorization request to the merchant's payment authorization request based on merchant and transaction details present in both requests. The payment processor 360 returns the authorization response to the merchant website 350. The merchant website 350 acts on the payment authorization result either by completing the exchange of goods or services to the consumer for an approval, or by requesting an alternative means of payment for a decline. The payment processor also returns a response to the consumer approved authorization to the originating payment network 370, who in turns forwards the response to the integrative vault 100/integrative vault provider. The integrative vault 100/integrative vault provider may notify the consumer's access device 200 of the authorization outcome.

While the actual payment instrument details will be provided to the payment network 370 in this embodiment, it is at the discretion of the payment network 370 as to whether to forward on the complete payment instrument identifier, to partially mask it, or to provide a suitable, non-high value token as a substitute, thus limiting the promulgation of the consumer payment instrument details across multiple payment network entities.

Also, while the authorization process illustrated in this embodiment requires changes to the traditional payment network 370 and payment processor 360 processing, it provides each entity with a completed authorization request to be used in its settlement and fund movement processing. As with the previous embodiments, the payment authorization is simply a means to ensure the payer has sufficient funds in the account associated with the payment instrument to cover the amount of the payment and the payment instrument issuer's commitment to hold the funds. Funds are not typically moved among the payment network entities until the merchant submits a settlement transaction for the authorized payment to the payment processor 360. The payment processor 360, or in many cases, the merchant's bank, submits the settlement transaction to the payment network 370 who ultimately presents the settlement transaction to the payment instrument issuer 320. The payment instrument issuer 320 affects the payee's account based on the settlement transaction and settles the funds with the payment network 370, who settles with the payment processor 360, who settles with the merchant's bank, who finally transfers fund to the merchant's account to settle the payment. At this point, the payment transaction is completed.

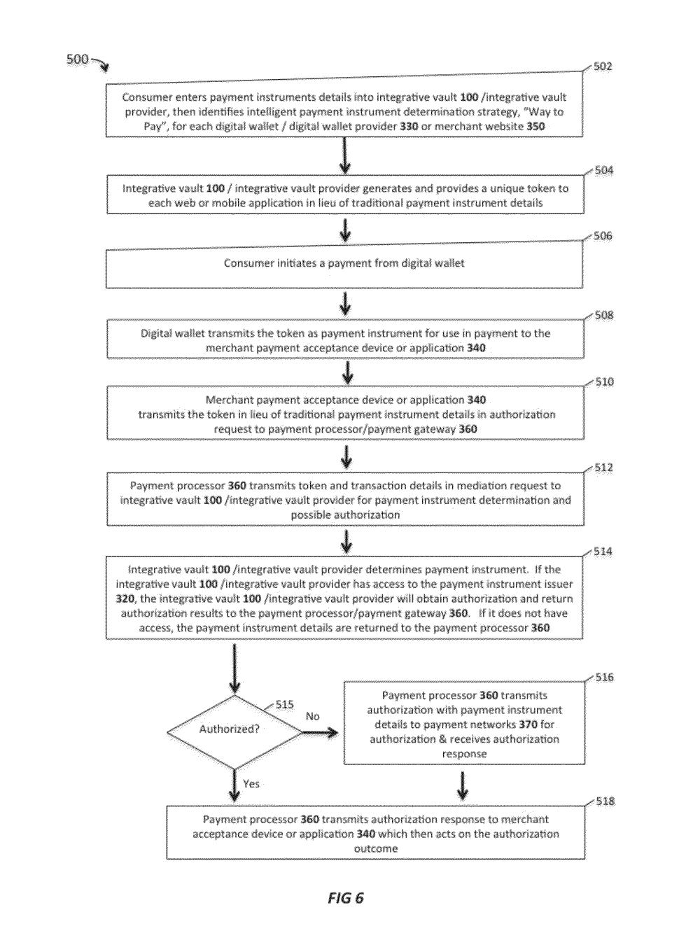

FIG. 6 is a flow diagram that illustrates the high level steps/acts of one embodiment of the integrative vault 100 payment process.

Referring to FIG. 6, step/act 500 is the start of the process and assumes the consumer has previously logged onto the vault account using his/her access device 200, has been authenticated, and has established his/her vault account. Continuing with the setup at step/act 502, the consumer enters payment instruments details into the integrative vault 100 and/or provides those details to the integrative vault provider, then identifies intelligent payment instrument determination strategy, “Way to Pay”, for each digital wallet/digital wallet provider 330 or merchant website 350. To ensure the vault contents are secure and unreadable by unauthorized users or hackers, all sensitive consumer information such as payment instrument credentials, other cards/accounts, documents, personal identifying details, and the like are encrypted by integrative vault 100/integrative vault provider. In step/act 504, the integrative vault 100/integrative vault provider generates and may provide in advance a unique token via an interface to each digital wallet/digital wallet provider 330 or merchant website 350 in lieu of traditional payment instrument details. Alternatively, tokens may be delivered in the moment of the payment transaction. Once the consumer's vault has been provisioned with payment instruments and wallets or websites, the remaining steps/acts of the FIG. 6 flow may be repeated for each payment.

In step/act 506, the consumer initiates a payment from his/her digital wallet at a merchant to facilitate the exchange of funds for goods or services. In step/act 508, the digital wallet or consumer's device transmits the token as a payment instrument for use in payment with a merchant payment acceptance device or application 340. The merchant payment acceptance device or application 340 should be capable of accepting a token or payment instrument via the means employed by the digital wallet or consumer's device for transmission.

In step/act 510, the merchant payment acceptance device or application 340 transmits the token in an authorization request to the payment processor/payment gateway 360. In this exemplary embodiment, it is assumed the token requires meditation, but those skilled in the art can easily envision an alternative embodiment where the token is routable as-is and does not require mediation. The payment processor 360 transmits the token and transaction details in a mediation request to the integrative vault 100/integrative vault provider for payment instrument determination and possible authorization in step/act 512. If the payment processor has relationships with more than one integrative vault provider, the initial portion of the token may be used to identify the specific integrative vault provider, and thus determine routing of the mediation request.

Continuing with step/act 514 of FIG. 6, the integrative vault 100/integrative vault provider determines the payment instrument to use based on the “Way to Pay” prioritization strategy defined by the consumer. If the integrative vault 100/integrative vault provider has access to the payment instrument issuer 320, the integrative vault 100/integrative vault provider will obtain authorization and return authorization results to the payment processor/payment gateway 360. If it does not have access, the payment instrument details are returned to the payment processor 360. Once the payment instrument credentials are returned to the payment processor 360, the integrative vault 100/integrative vault provider may inform the payment instrument issuer 320 of the consumer's request for payment credentials and the context in which the request was made such as consumer location, access device identifier, merchant identifier, merchant category, merchant location, date, time of day, and the like.

In step/act 515, the payment processor 360 will examine the response of the mediation request. If the payment details were simply returned, then the payment processor 360 transmits an authorization request with the payment instrument details to payment networks 370 for authorization and receives an authorization response as specified in step/act 516.

Once the payment processor 360 receives the authorization response, either from the integrative vault 100/integrative vault provider or from the payment network 370, it transmits in step/act 518 the authorization response to the merchant payment acceptance device or application 340, which then acts on the authorization outcome.

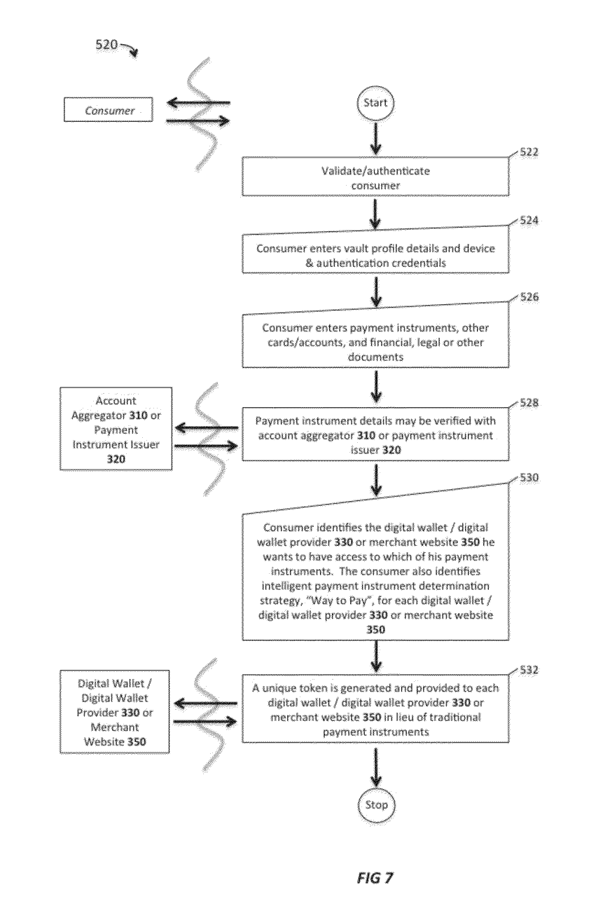

FIG. 7 is a flow diagram that illustrates the consumer vault registration process.

Referring to FIG. 7, step/act 520 is the start of the process and assumes the consumer has accessed the integrative vault 100/integrative vault provider using his/her access device 200. In step/act 522, the integrative vault 100/integrative vault provider, using one or more of the authentication mechanisms previously described, authenticates the consumer. In step/act 524, the consumer takes further steps/acts to establish his/her vault by entering personal information such as his/her name, addresses, email addresses, telephone numbers, other contact details, demographic details, preferences such as preferred method of communication, user defined authentication credentials such as password or PIN, and the like.

Once the consumer has established his/her vault account, the consumer provisions his/her vault with his/her payment instruments, other cards/accounts, and financial, legal or other documents. To ensure the vault contents are secure and unreadable by unauthorized users or hackers, all sensitive consumer information such as payment instrument credentials, other cards/accounts, documents, personal identifying details, and the like are encrypted by the integrative vault 100/integrative vault provider.

In step/act 526, the consumer registers his/her payment instruments. The consumer may select from a menu of payment instrument issuers 320 with which the integrative vault provider has established direct or indirect relationships, may manually enter the details, capture the details via OCR or the like. If the integrative vault provider has a direct relationship with the payment instrument issuers 320 or indirectly via an account aggregator 310, the consumer is asked for his/her payment instrument logon credentials. In step/act 528, the integrative vault 100/integrative vault provider, leveraging these credentials and/or the access they provide, communicates with the payment instrument issuers 320 or account aggregator 310 to verify the payment instrument details and retrieve additional details such as balance, expiration date, card verification code, interest rate, payment due date, transaction history, and the like.

Once the consumer has completed his/her payment instrument registration, the consumer, in step/act 530, identifies the digital wallet/digital wallet provider 330 or merchant websites 350 he/she wants to have access to which of his/her payment instruments. The consumer also identifies intelligent payment instrument determination strategy, “Way to Pay”, for each digital wallet/digital wallet provider 330 or merchant website 350. The strategy may be based on transactional details such as transaction amount, merchant identifier, merchant category, merchant location, date, time of day, and the like; merchant details such as which payment instruments are accepted; payment instrument details such as balance, credits, open to buy, loyalty/rewards incentives and the like; consumer activity such as counts and amounts of recent or previous payment activities; or any combination thereof. The strategy may be inclusive or exclusive with consideration to certain transactional or payment instrument details. Further, the integrative vault provider or the payment instrument issuer 320 may dictate some predefined payment instrument determination strategy definitions. For example, a proprietary gift card such as Starbucks™'s may only be used at Starbuck's merchant locations, or health saving account/flexible spending account cards may only be used at merchants having a qualifying merchant category or specific industry code.

Continuing with step/act 532 of FIG. 7, the integrative vault 100/integrative vault provider may generate a unique token and provide the unique token in advance to each digital wallet/digital wallet provider 330 or merchant website 350 in lieu of traditional payment instrument details. Alternatively, tokens may be delivered in the moment of the payment transaction. At this point, the consumer may initiate payments via his/her provisioned digital wallets or merchant websites.

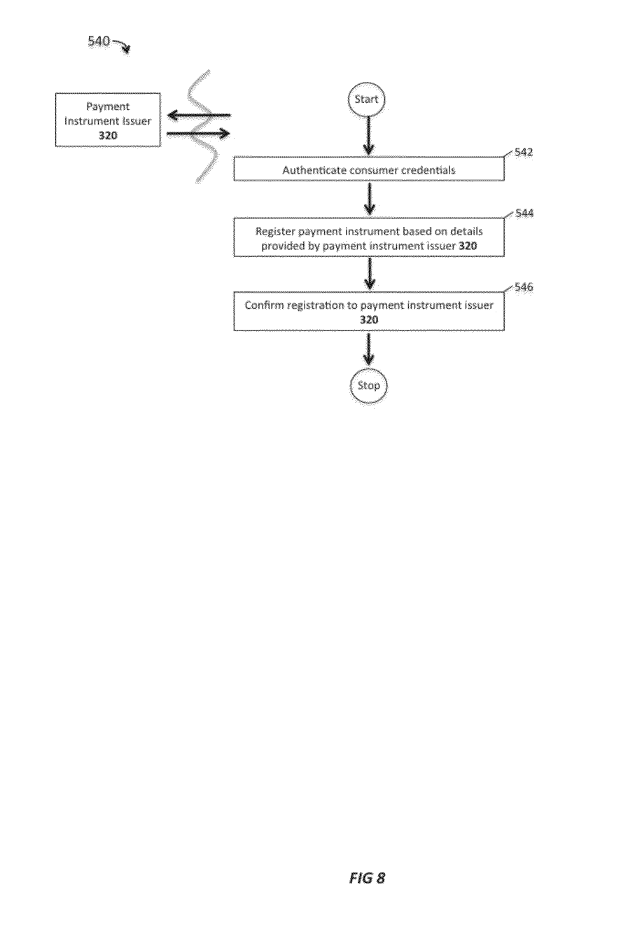

FIG. 8 is a flow diagram that illustrates the remote consumer payment instrument registration process. In the embodiment depicted in FIG. 8, the payment instrument issuer 320 is able to push a consumer's payment instrument details to the consumer's integrative vault 100/integrative vault provider for registration. To accomplish this, the integrative vault provider has an established relationship with the payment instrument issuer 320 that facilitates the remote registration of a consumer's payment instrument.

Referring to FIG. 8, step/act 540, the process is initiated by payment instrument issuer 320 having obtained the consumer's access credentials for the integrative vault 100/integrative vault provider and having issued a payment instrument to the consumer. The payment instrument issuer 320 communicates with integrative vault 100/integrative vault provider and transits the consumer's credentials. In step/act 542, the integrative vault 100/integrative vault provider using one or more of the authentication mechanisms previously described authenticates the consumer's access credentials. In step/act 544, the payment instrument issuer 320 then communicates the payment instrument details to the integrative vault 100/integrative vault provider. Payment instrument details includes card or account identifier and may include details such as balance, card verification code, expiration date, interest rate, payment due date, transaction history, and the like. The registration process is completed in step/act 546 with the integrative vault 100/integrative vault provider confirming the registration of the payment instrument with the payment instrument issuer 320. This same means of communication between the integrative vault 100/integrative vault provider and the payment instrument issuer 320 may be used to communicate the token to be used to initiate the payment transaction at the merchant payment acceptance device or application 340, merchant website 350 or payment acceptance portal thereof.

Those skilled in the art can easily see how this remote consumer payment instrument registration process can also allow for provisioning of payment instruments to the integrative vault 100/integrative vault provider via a digital wallet, website, or other third party rather than originating from a payment instrument issuer.

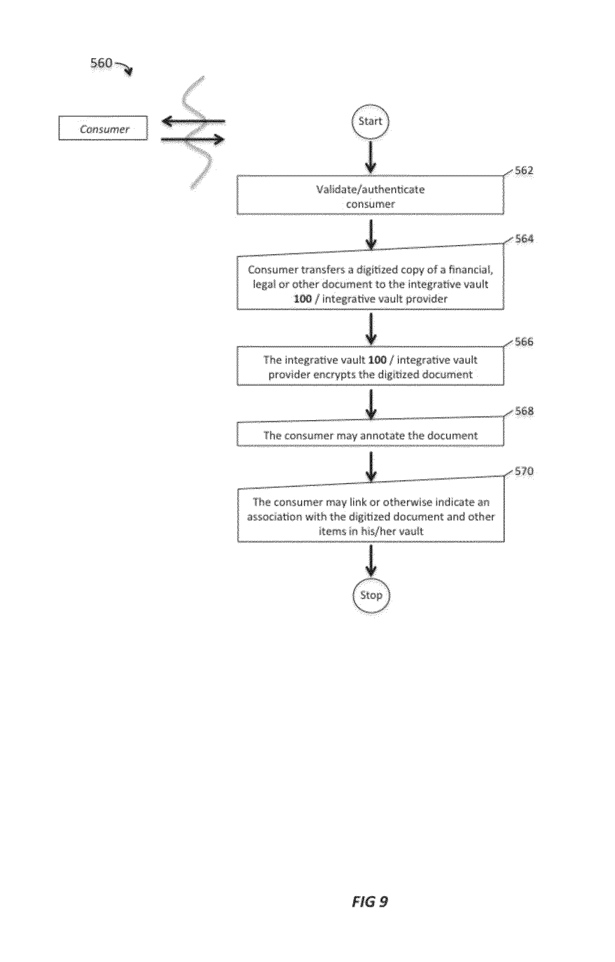

FIG. 9 is a flow diagram that illustrates the consumer document registration process. The integrative vault 100/integrative vault provider provides for secure storage not only of a consumer's financial accounts, but also for storage of a consumer's financial, legal or other important documents.

Referring to FIG. 9, step/act 560 is the start of the process and assumes the consumer has accessed the integrative vault 100/integrative vault provider using his/her access device 200. In step/act 562, the integrative vault 100/integrative vault provider authenticates the consumer using one or more of the authentication mechanisms previously described.

In step/act 564, the consumer transfers a digitized copy of a financial, legal or other document to the integrative vault 100/integrative vault provider. To ensure the document contents are secure and unreadable by unauthorized users or hackers, the integrative vault 100/integrative vault provider encrypts the digitized document for storage in the consumer's vault in step/act 566. In step/act 568, the consumer may provide document details or notes in the form of annotations, which are stored in association with the encrypted document. The consumer may select from a set of default annotation forms based on document types, or may create his/her own customized forms. Further, in step/act 570, the consumer may link or otherwise indicate an association with the encrypted document and other items in his/her vault. The annotations and linkage aids the consumer in future document retrieval.

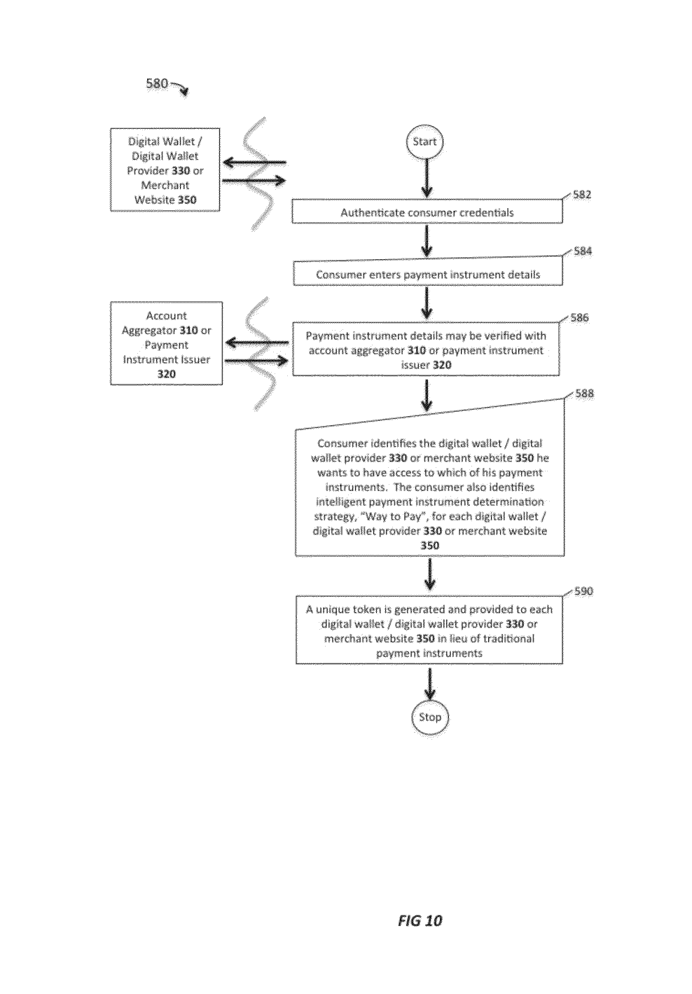

FIG. 10 is a flow diagram that illustrates the remote consumer digital wallet or merchant website registration process. In the embodiment depicted in FIG. 10, the consumer is able to remotely register a digital wallet or merchant website. The digital wallet/digital wallet provider 330 or merchant website 350 is able to push a consumer's digital wallet or merchant website details to the consumer's integrative vault 100/integrative vault provider for registration. To accomplish this, the integrative vault provider has an established relationship with digital wallet/digital wallet provider 330 or merchant website 350 that facilitates the remote registration of a consumer's digital wallet or merchant website.

Referring to FIG. 10, step/act 580, the process is initiated by digital wallet/digital wallet provider 330 or merchant website 350 having obtained the consumer's access credentials for the integrative vault 100/integrative vault provider. The digital wallet/digital wallet provider 330 or merchant website 350 communicates with integrative vault 100/integrative vault provider and establishes access via the consumer's credentials. In step/act 582, the integrative vault 100/integrative vault provider authenticates the consumer's credentials using one or more of the authentication mechanisms previously described.

In step/act 584, the consumer enters his/her payment instrument details. This is an optional step/act, as the payment instruments may have already been registered in the consumer's vault. If the consumer has elected to entered payment instruments, the digital wallet/digital wallet provider 330 or merchant website 350 communicates the payment instrument details to the integrative vault 100/integrative vault provider. If the integrative vault provider has a direct relationship with the payment instrument issuers 320 or indirectly via an account aggregator 310, the consumer is asked for his/her payment instrument logon credentials. In step/act 586, the integrative vault provider, leveraging these credentials and/or the access they provide, communicates with the payment instrument issuers 320 or account aggregator 310 to verify the payment instrument details and retrieve additional details such as balance, expiration date, card verification code, interest rate, payment due date, transaction history, and the like

Once the consumer has completed his/her payment instrument registration, the consumer, in step/act 588, identifies intelligent payment instrument determination strategy, “Way to Pay” for digital wallet/digital wallet provider 330 or merchant website 350. The strategy may be based on transactional details such as transaction amount, merchant identifier, merchant category, merchant location, date, time of day, and the like; merchant details such as which payment instruments are accepted; payment instrument details such as balance, credits, open to buy, loyalty/rewards incentives and the like; consumer activity such as counts and amounts of recent or previous payment activities; or any combination thereof. The strategy may be inclusive or exclusive with consideration to certain transactional or payment instrument details. Further, the integrative vault provider or the payment instrument issuer 320 may dictate some predefined payment instrument determination strategy definitions. For example, a proprietary credit card such as Valero™ may only be used at Valero merchant locations, or health saving account/flexible spending account cards may only be used at merchants having a qualifying merchant category or specific industry code. Data specific to the registered payment instruments, digital wallets or desired merchant websites, and the intelligent payment instrument determination strategy is stored in the database of the integrative vault 100/integrative vault provider.

Continuing with step/act 590 of FIG. 10, a unique token may be then generated and provided in advance to the digital wallet/digital wallet provider 330 or merchant website 350 in lieu of traditional payment instrument details. Alternatively, tokens may be delivered in the moment of the payment transaction. The token may be generated by the payment instrument issuer 320 and/or by the integrative vault 100/integrative vault provider. At this point, the consumer may initiate payments via his/her provisioned digital wallet or merchant website.

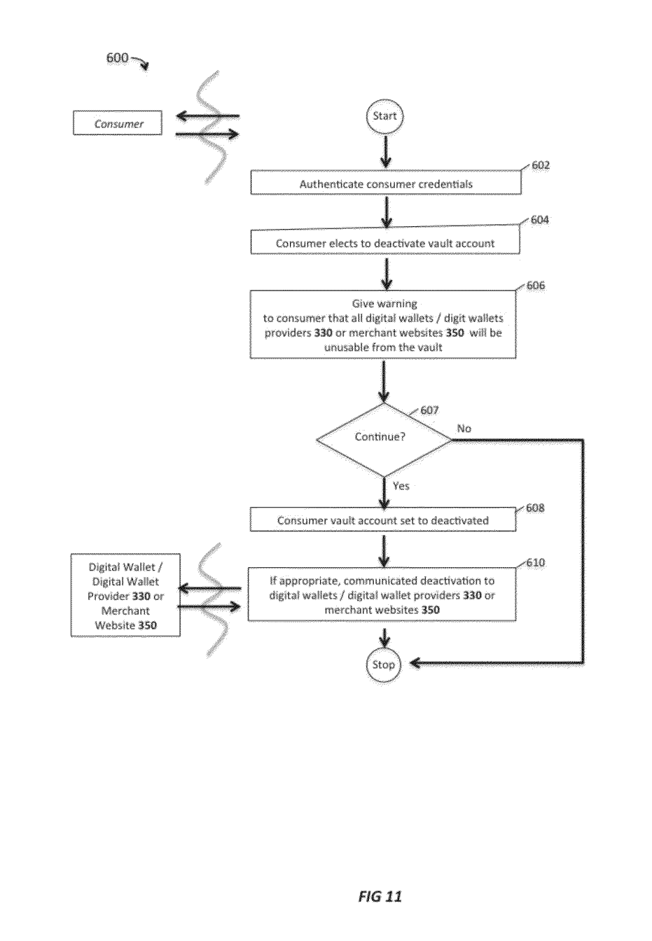

FIG. 11 is a flow diagram that illustrates the consumer vault deactivation process. In this embodiment, the consumer may deactivate his/her vault. This may be done prophylactically to prevent fraudulent transactions during an expected extended period of non-use, to terminate use of the service of the integrative vault 100, or for other consumer reasons.

Referring to FIG. 11, step/act 600 is the start of the process and assumes the consumer has accessed the integrative vault 100/integrative vault provider using his/her access device 200. In step/act 602, integrative vault 100/integrative vault provider authenticates the consumer using one or more of the authentication mechanisms previously described.

In step/act 604, the consumer elects to deactivate his/her vault. In step/act 606, the consumer is given a warning that all his/her digital wallets or merchant websites 350 will be unusable from the vault. In step/act 607, the consumer is asked whether he/she wants to continue with the deactivation. If the consumer elects to continue, then the consumer's vault status is set to “deactivated” in step/act 608. At this point, the vault will be unavailable to satisfy any payment authorization or token mediation request presented to the integrative vault 100/integrative vault provider. In step/act 610, if appropriate, the deactivation is communicated to each registered digital wallet/digital wallet provider 330 or merchant website 350.

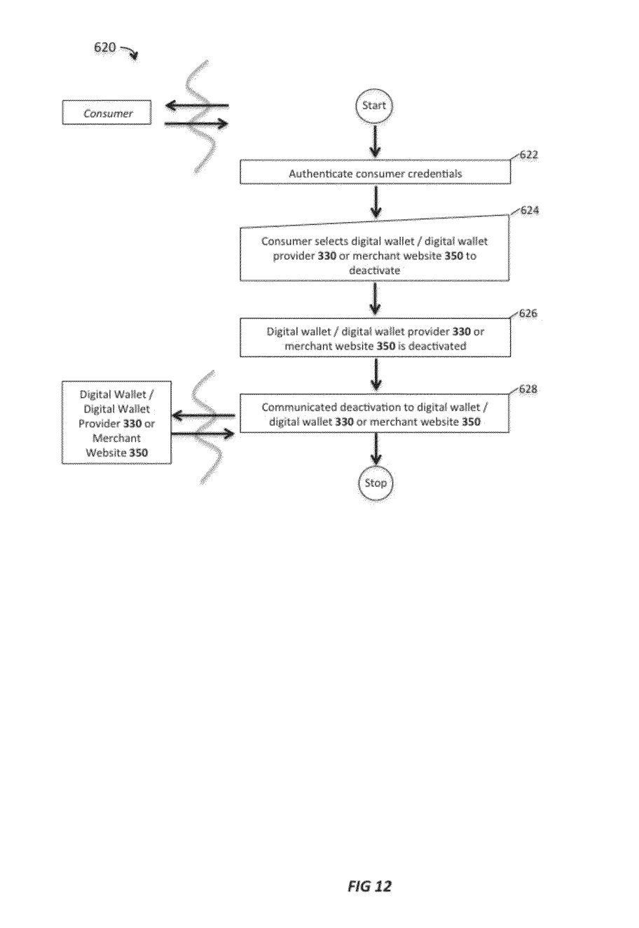

FIG. 12 is a flow diagram that illustrates the consumer digital wallet or merchant website deactivation process. In the embodiment depicted in FIG. 12, the consumer may deactivate a digital wallet or merchant website registered in his/her vault. This may be done prophylactically to prevent fraudulent transactions during an expected extended period of non-use, to terminate use of the digital wallet or merchant website, lost or stolen access device, or for other consumer reasons.

Referring to FIG. 12, step/act 620 is the start of the process and assumes the consumer has accessed the integrative vault 100/integrative vault provider using his/her access device 200. In step/act 622, the integrative vault 100/integrative vault provider authenticates the consumer using one or more of the authentication mechanisms previously described.

In step/act 624, the consumer selects a menu option to deactivate a specific digital wallet or merchant website registered in his/her vault. In step/act 626, digital wallet or merchant website status is set to “deactivated”. At this point, the integrative vault 100/integrative vault provider will be unavailable to satisfy any payment authorization or token mediation request for the digital wallet or merchant website presented to the integrative vault 100/integrative vault provider. In step/act 628, the deactivation is communicated to the registered digital wallet/digital wallet provider 330 or merchant website 350.

Those skilled in the art can easily see how a consumer may deactivate a specific payment instrument just as an integrative vault or wallet may be deactivated. At this point, the payment instrument will no longer be associated or be available to be associated with a digital wallet or merchant website within the consumer's vault, and will be unable to satisfy any payment authorization or token mediation request. The current invention also contemplates the communication an appropriate status such as ‘lost’, ‘stolen’, or the like to the payment instrument issuer 320 to indicate that the consumer has encountered a problem with the payment instrument and does not want future transactions for any source authorized against the payment instrument account.

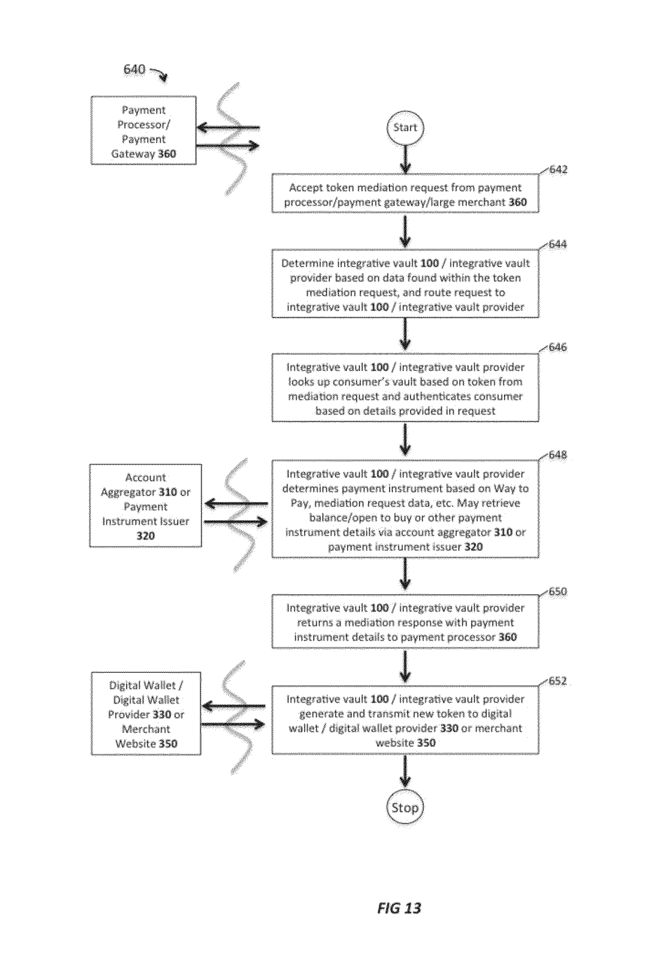

FIG. 13 is a flow diagram that illustrates the token mediation request process where tokens are generated and provided in advance of a payment. Those skilled in the art can easily envision an alternative embodiment where the token is generated and delivered in the moment of the payment. This embodiment assumes the consumer has previously established his/her vault and registered his/her payment instruments and digital wallets and merchant websites. The consumer initiates a payment from his/her digital wallet or merchant website to facilitate the exchange of funds for goods or services. Further, step/act 640 is the start of the process and assumes a payment authorization request with an embedded consumer's token and/or consumer's token details was initiated from a merchant payment acceptance device or application 340 or merchant website 350 and transmitted to a payment processor 360. In turn, the payment processor 360 transmits the token and/or token details and other consumer and transaction details in mediation request to the integrative vault 100/integrative vault provider for payment instrument determination.

Continuing with step/act 642, the integrative vault 100/integrative vault provider receives the mediation request from the merchant payment acceptance device or application 340 or merchant website 350 and transmitted to a payment processor 360. At step/act 644, the integrative vault 100 determines the integrative vault provider and routes the request to the appropriate integrative vault provider as the system may be implemented in a multi-tenant configuration.

In step/act 646, the consumer is authenticated by the integrative vault 100/integrative vault provider based on details provided in the request using one or more of the authentication mechanisms previously described. In step/act 648, the integrative vault 100/integrative vault provider determines the payment instrument to use based on the “Way to Pay” prioritization strategy defined by the consumer. If required by the strategy, the integrative vault 100/integrative vault provider may request balance or open to buy or other payment instrument details from the account aggregator 310 or the payment instrument issuer 320 to use in payment instrument decision making. In step/act 650, once the payment instrument is resolved, the integrative vault 100/integrative vault provider returns the payment instrument details to the payment processor 360. Once the payment instrument credentials are returned to the payment processor 360, the integrative vault 100/integrative vault provider may inform the payment instrument issuer 320 of the consumer's request for payment credentials and the context in which the request was made such as consumer location, access device identifier, merchant identifier, merchant category, merchant location, date, time of day, and the like.

The payment processor 360 transmits an authorization request with the payment instrument details to payment networks 370 for authorization and receives an authorization response. Once the payment processor 360 receives the authorization response, it transmits the authorization response to a merchant payment acceptance device or application 340 or merchant website 350, which then acts on the authorization outcome.

In step/act 652, integrative vault 100/integrative vault provider generates a new, unique token for the digital wallet or merchant website and transmits the token to the digital wallet/digital wallet provider 330 or merchant website 350 used in initiating the payment authorization.

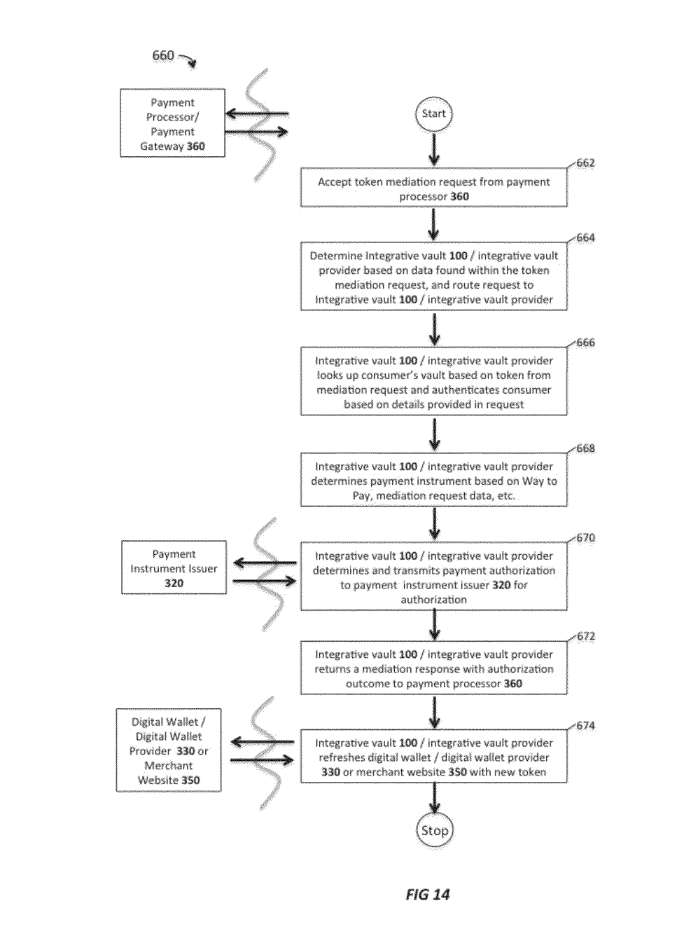

FIG. 14 is a flow diagram that illustrates the token mediation request with payment authorization process where tokens are generated and provided in advance of a payment. Those skilled in the art can easily envision an alternative embodiment where the token is generated and delivered in the moment of the payment. This embodiment is similar to that of FIG. 13 with the exception that the integrative vault 100/integrative vault provider has an interface with the payment instrument issuer 320 allowing for authorization processing. Further, the integrative vault 100/integrative vault provider has a role in the value chain of the transaction requiring it to settle funds between the payment processors 360 and the payment instrument issuers 320.

Step/act 660 is the start of the process and assumes the consumer has previously established his/her vault and registered his/her payment instruments and digital wallets and merchant websites. The consumer initiates a payment from his/her digital wallet or merchant website, and a payment authorization with an embedded consumer's token is initiated at a merchant payment acceptance device or application 340 or merchant website 350 and transmitted to a payment processor 360. In turn, the payment processor 360 transmits the token and transaction details in the mediation request to the integrative vault 100/integrative vault provider for payment instrument determination. It must be noted that upon delivery of payment token and other personal identity details to the digital wallet or merchant website 350, the integrative vault 100/integrative vault provider may inform the payment instrument issuer 320 of the consumer's request for payment credentials and the context in which the request was made such as consumer location, access device identifier, merchant identifier, merchant category, merchant location, date, time of day, and the like.

Continuing with step/act 662, the integrative vault 100/integrative vault provider receives the mediation request from the merchant payment acceptance device or application 340 or merchant website 350 and transmitted to a payment processor 360. At step/act 664, the integrative vault 100 determines the integrative vault provider and routes the request to the appropriate integrative vault provider, as the system may be implemented in multi-tenant configuration.

In step/act 666, the consumer is authenticated by the integrative vault 100/integrative vault provider based on details provided in the request using one or more of the authentication mechanisms previously described. In step/act 668, the integrative vault 100/integrative vault provider determines the payment instrument to use based on the “Way to Pay” prioritization strategy defined by the consumer. If required by the strategy, the integrative vault 100/integrative vault provider may request balance or open to buy or other payment instrument details from the account aggregator 310 or the payment instrument issuer 320 to use in payment instrument decision making.

In step/act 670, the integrative vault 100/integrative vault provider transmits a payment authorization request to the payment instrument issuer 320. The payment instrument issuer 320 authorizes the request and returns authorization results to the integrative vault 100/integrative vault provider. In step/act 672, the integrative vault 100/integrative vault provider forwards the results of the authorization response in the mediation response to the payment processor 360.

The payment processor 360 will examine the response of the mediation request. If the payment details were simply returned, then the payment processor 360 transmits an authorization request with the payment instrument details to payment networks 370 for authorization and receives an authorization response. Once the payment processor 360 receives the authorization response, either from the integrative vault 700/integrative vault provider or from the payment network 370, it transmits the authorization response to the merchant payment acceptance device or application 340, which then acts on the authorization outcome.

In step/act 674, integrative vault 100/integrative vault provider generates a new, unique token for the digital wallet or merchant website and transmits the token to the digital wallet/digital wallet provider 330 or merchant website 350 initiating the payment authorization.

Those skilled in the art will appreciate that the payment instrument in this embodiment may be, for example, a loyalty card, the payment instrument issuer 320 may be a loyalty card issuer, and the payment transaction may be a redemption of reward credits for goods or services.

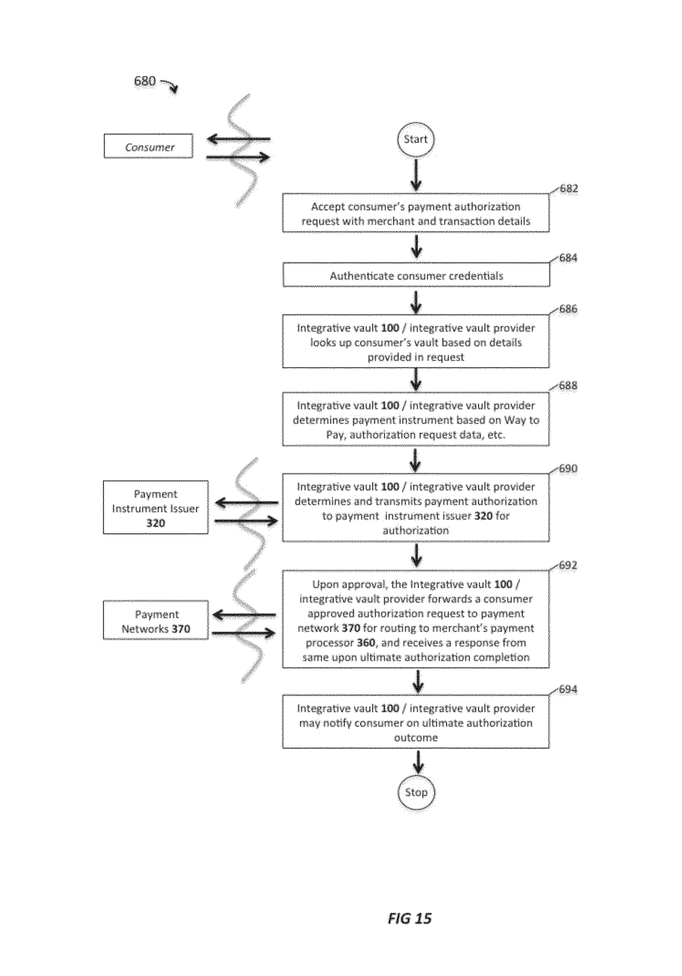

FIG. 15 is a flow diagram that illustrates the alternative digital wallet payment authorization process. The embodiment involves an alternative digital wallet implementation where the merchant is never presented with consumer's payment instrument details. In this embodiment, the consumer registers his/her payment instruments and defines the “Way to Pay” strategy for the alternative digital wallet. No token is generated or exchanged with the digital wallet/digital wallet provider 330, though the provider may be used for vault setup and maintenance.

In this embodiment, the merchant payment acceptance device or application 340 is capable of communicating merchant and transaction details to the consumer's digital wallet provided on or accessible from the access device 200. The method of mobile device communication 420 is dependent on the capabilities of the access device 200, the digital wallet provided on or accessible from the access device 200, and the merchant's payment acceptance device or application 340, and is outside the scope of this invention. The consumer captures merchant and transaction details with his/her access device 200, and transmits a consumer payment authorization request directly to his/her integrative vault 100/integrative vault provider. Concurrently, the merchant using his/her merchant payment acceptance device or application 340 transmits his/her portion of the payment authorization request to his/her payment processor 360. This, however, is performed outside the integrative vault 100/integrative vault provider processing illustrated in FIG. 15.

Step/act 680 starts the process when the integrative vault 100/integrative vault provider receives the consumer's payment authorization request. In step/act 682, the integrative vault 100/integrative vault provider performs an authentication process to ascertain whether the payer initiating the payment is permitted access to the payment instruments stored in the consumer's vault. The authentication method may make use of data transmitted in the mediation request such as PIN, card verification code, access device identifier, and the like in step/act 684.

In step/act 686, the integrative vault 100/integrative vault provider looks up the consumer's vault. In the payment authorization request, the consumer may dictate the payment instrument to use in the authorization. A payment instrument nickname or other generic identifier known to both the digital wallet and the consumer's integrative vault 100/integrative vault provider may be communicated in the consumer's payment authorization request. If no payment instrument is identified in the request, the digital wallet's “Way to Pay” strategy will be invoked to make the payment instrument determination.

In step/act 688, the integrative vault 100/integrative vault provider determines the payment instrument to use based on the “Way to Pay” prioritization strategy defined by the consumer or dictated in the consumer's request. If required by the strategy, the integrative vault 100/integrative vault provider may request balance or open to buy or other payment instrument details from the account aggregator 310 or the payment instrument issuer 320 to use in payment instrument decision making.

In step/act 690, the integrative vault 100/integrative vault provider transmits a payment authorization request to the payment instrument issuer 320. The payment instrument issuer 320 authorizes the request and returns authorization results to the integrative vault 100/integrative vault provider. In step/act 692, the integrative vault 100/integrative vault provider forwards a consumer approved authorization request to the payment network 370 for routing to the merchant's payment processor 360.

The payment network 370 routes the consumer approved authorization request, based on the merchant's details, such as a merchant acquirer financial institution identifier, to the merchant's payment processor 360. The payment processor 360 then marries the consumer approved authorization request to the merchant's payment authorization request based on merchant and transaction details present in both requests. The payment processor 360 returns the authorization response to the merchant payment acceptance device or application 340. The merchant acts on the payment authorization result either by completing the exchange of goods or services or advancing cash to the consumer for an approval, or by requesting an alternative means of payment for a decline. The payment processor 360 also returns a response to the consumer approved authorization to the originating payment network 370, who in turn forwards the response to the integrative vault 100/integrative vault provider. In step/act 694, the integrative vault 100/integrative vault provider may notify the consumer of the authorization outcome.

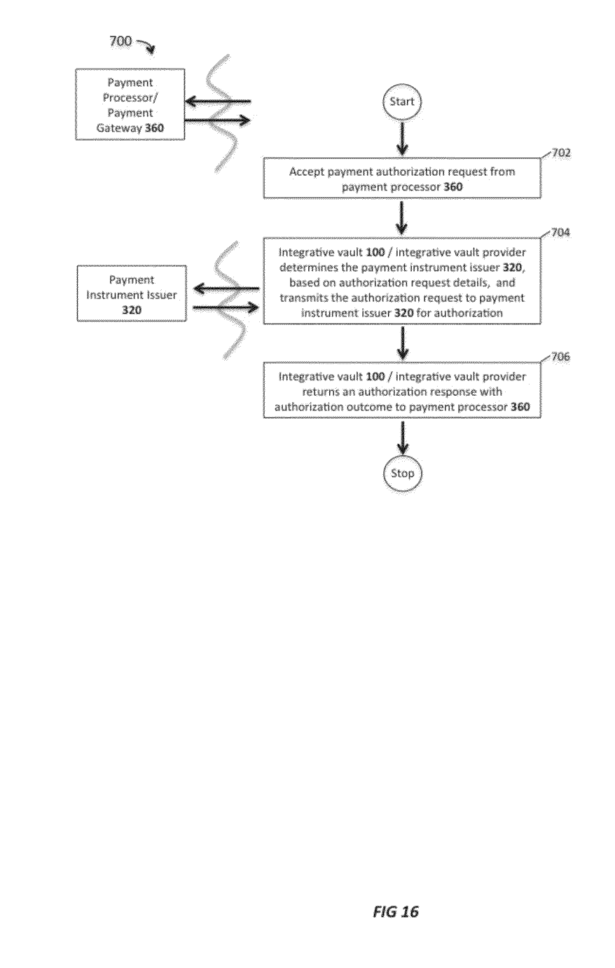

FIG. 16 is a flow diagram that illustrates the payment authorization request process. It stands to reason that while there are significant advantages to innovative aspects of the invention described herein, implementation of the technology needed to exploit these aspects may lag among payment network participants. As a result, there is need to be able to process traditional payment transactions. In this embodiment, the integrative vault 100/integrative vault provider is simply functioning as a traditional electronic payment switch, accepting payment transactions and routing them to the appropriate payment instrument issuer 320 for authorization.

Referring to FIG. 16, step/act 700, a payment processor 360 having received a payment authorization from a merchant payment acceptance device or application 340, merchant website 350, or another payment processor/payment gateway 360, transmits the payment authorization to the integrative vault 100/integrative vault provider for further processing.

In step/act 702, the integrative vault 100/integrative vault provider accepts the payment authorization request from the payment processor 360. In step/act 704, the integrative vault 100/integrative vault provider determines the payment instrument issuer 320, based on authorization request token and other details, and transmits the authorization request to payment instrument issuer 320 for authorization. Upon receiving the authorization response from the payment instrument issuer 320, the integrative vault 100/integrative vault provider returns the payment authorization response to the payment processor 360 in step/act 706. Once the payment instrument credentials are returned to the payment processor 360, the integrative vault 100/integrative vault provider may inform the payment instrument issuer 320 of the consumer's request for payment credentials and the context in which the request was made such as consumer location, access device identifier, merchant identifier, merchant category, merchant location, date, time of day, and the like. The payment processor 360, in turn, forwards the response to the initiating merchant payment acceptance device or application 340, merchant website 350, or another payment processor/payment gateway 360 where the transaction is completed.

Continuing with the rationale behind FIG. 16, there may be a need to be able to process a mobile wallet payment transaction where the merchant payment acceptance device or application 340 or payment processor 360 cannot accept a token, but must be provided with the actual payment instrument details. In this embodiment, the integrative vault 100/integrative vault provider simply functions as the authenticator of the consumer before allowing the consumer access to the payment instruments stored in his/her vault. Once authenticated, the consumer may elect to use his/her default “Way to Pay” or select a specific payment instrument for use in the payment. The payment instrument details are communicated from the mobile wallet on the consumer's access device 200, such as a smartphone 210, to the merchant payment acceptance device or application 340 to initiate payment processing via the traditional payment participants. The method of mobile device communication 420 and credential security is dependent upon the capabilities of the access device 200, the digital wallet provided on or accessible from the access device 200, and the merchant's payment acceptance device or application 340, and is outside the scope of this invention.

In another embodiment, the integrative vault 100/integrative vault provider provides payment processing for a payment initiated by a healthcare provider.

In an exemplary embodiment, the consumer has established his/her vault account, registered payment instruments, and uses his/her specialized digital wallet to manage healthcare payments, appointments, prescriptions, medical records, medical receipts, and the like. Assume the consumer has two payment instruments defined for his/her healthcare digital wallet: a flexible spending account (FSA) credit card and a MasterCard credit card. Further, the consumer prefers to use his/her FSA card as the funding source for all co-payment and deductible payments. Also, the consumer prefers to use his/her MasterCard credit card once the funds in the FSA account are exhausted.

Continuing with the embodiment, the consumer initiates a payment from his/her digital wallet at a healthcare provider to facilitate payment. The digital wallet transmits the token as a payment instrument for use in payment with the healthcare provider's merchant payment acceptance device or application 340.

The merchant payment acceptance device or application 340 transmits the token in lieu of traditional payment instrument details in an authorization request to the payment processor/payment gateway 360. In this exemplary embodiment, it is assumed the token requires meditation, but those skilled in the art can easily envision an alternative embodiment where the token is routable as-is and does not require mediation. The payment processor 360 transmits token and transaction details in a mediation request to the integrative vault 100/integrative vault provider for payment instrument determination and possible authorization.

The integrative vault 100/integrative vault provider determines the payment instrument to use based on the “Way to Pay” prioritization strategy defined by the consumer. In this embodiment, the integrative vault 100/integrative vault provider will request the FSA's account balance via the account aggregator 310 or payment instrument issuer 320. If there is sufficient balance to cover the transaction amount, then the FSA account will be used as the payment instrument. If not, then the consumer's MasterCard will be used. The integrative vault 100/integrative vault provider then returns a mediation response with the resolved payment instrument details to the payment processor 360.

The payment processor 360 will examine the response of the mediation request. If the payment details were simply returned, then the payment processor 360 transmits an authorization request with the payment instrument details to the payment networks 370 for authorization and receives an authorization response as specified.

Once the payment processor 360 receives the authorization response from the payment network 370, it transmits the authorization response to the healthcare provider's merchant payment acceptance device or application 340, which then acts on the authorization outcome.

The consumer is typically presented with a receipt of his/her payment. Assuming the transaction was completed using the consumer's FSA card, the consumer may scan a digitized version of the receipt into his/her vault linking it to his/her FSA card for reference and tracking of funds usage.

In another embodiment, the integrative vault 100/integrative vault provider provides payment processing for a person-to-person payment using a payment instrument registered in the first person's vault.

In an exemplary embodiment, the consumer has established his/her vault account, has registered payment instruments, and his/her digital wallet is capable of initiating person-to-person payments. Continuing with the embodiment, the first person, the payer, initiates a payment to the second person, the payee, from the first person's digital wallet. The first person provides the amount of the payment and the second person's checking account, credit card, email address, phone number, Facebook identifier, LinkedIn identifier, Twitter identifier, or the like, to enable the second person to receive payment and/or receive instructions to receive funds. The payment request is then sent to the integrative vault 100/integrative vault provider.

Upon receiving the first person's person-to-person payment request, the consumer's integrative vault 100/integrative vault provider performs an authentication process to ascertain whether the payer initiating the payment is permitted access to the payment instruments stored in the consumer's vault. Once authenticated, the consumer may elect to use his/her default “Way to Pay” or select a specific payment instrument for use in the payment.

The person-to-person payment may be processed by a variety of means. In this example, the person-to-person payment is sent to a third party money transmitter agency to affect funds for both the first and second persons. The means used to process the person-to-person payment will dictate the type of payment instrument that may be used by the first person for the payment, and will dictate the method the second person may use to receive payment and/or payment instructions.

In another embodiment, the integrative vault 100/integrative vault provider provides for bill pay payment processing using payment instruments registered in a consumer's vault.

In an exemplary bill pay embodiment, the consumer may select a biller with which the integrative vault provider has established direct or indirect relationships, or may manually enter the details. If the integrative vault provider has a direct relationship with the biller or biller consolidator 380, the consumer is asked for his/her billing account details. The integrative vault 100/integrative vault provider using the account details communicates with the biller or biller consolidator 380 to verify the account and retrieve details such as amount due, due date, payment history, an electronic copy of the bill, and the like.

The consumer may set up a recurring payment or enter the amount of the bill, the date that he/she wants it paid, and which payment instrument to use for the payment. The consumer may set up self-notification to be sent during a specified period before the bill is due or when a bill is overdue.

When a bill is to be paid, the integrative vault 100/integrative vault provider initiates the debit of the consumer's payment instrument and the credit to the biller. The process to debit the consumer's payment instrument depends on the instrument type and the relationship of the integrative vault 100/integrative vault provider with the payment issuer. The method may include initiation of an ACH, credit or debit transaction, direct debit of an account, or the like. The process to credit the biller depends on the relationship of the integrative vault 100/integrative vault provider with the biller. The method may include initiation of an ACH, direct debit of an account, or the like. If the integrative vault 100/integrative vault provider does not have a relationship with the biller, a check could be sent to the biller.

In yet another embodiment, the integrative vault 100/integrative vault provider provides for secure storage of a consumer's financial, legal or other important documents.

In an exemplary embodiment, the consumer transfers a digitized copy of a financial, legal or other document to the integrative vault 100/integrative vault provider. The consumer may, for example, scan and create a digitized copy of his/her auto loan papers. To ensure the document contents are secure and unreadable by unauthorized users or hackers, the integrative vault 100/integrative vault provider encrypts the digitized document for storage in the consumer's vault as it does with all vault entries. The consumer may provide document details or notes in the form of annotations, which are stored in association with the encrypted document. Continuing with the example of the auto loan papers, the consumer may indicate that the document is “auto loan papers”, designate the signatory and any co-signatories of the loan, date executed, loan amount, interest rate, duration, number of payments, amount of each payment, etc. The consumer may select from a set of default annotation forms based on document types, or may create his/her own customized forms. Next, the consumer may link or otherwise indicate an association with the encrypted document and other items in his/her vault. Documents may also be organized into folders by categories such as legal, assets, debts, family, and the like. The annotations, linkage, and folders aid the consumer in future document retrieval. In the case of the auto loan document, the consumer may link the document to an associated auto loan account also registered in his/her vault. This allows the consumer easy access to the loan papers should a problem or a question arises with the loan account that requires reference to the original loan papers.

In another embodiment, the consumer may store a digitized loan payment booklet in his/her vault, then link each loan payment transaction to the digitized booklet to track loan payments. In the event a question arises regarding the loan payment history, the consumer may retrieve the payment history and associated digitized booklet, and forward the information to the questioning party.

In yet another embodiment, the integrative vault 100/integrative vault provider provides for storage of a consumer's coupons, offers, and incentives.

In an exemplary embodiment, the consumer transfers a digitized copy of a coupon, offer, incentive or promotion to the integrative vault 100/integrative vault provider, or receives such an item in his/her vault from the advertisement and promotion management function 106 or a third party. The integrative vault 100/integrative vault provider will extract details from the offer including, for example, validity dates, times, merchants, merchant categories, amount or percentage of discount, and the like, to be used for annotation. The consumer may include additional annotation as needed. The consumer may link or otherwise indicate an association with the coupon to other items in his/her vault. Also, coupons may be organized into folders based on merchant, merchant category, or the like. The annotations, linkages, and folders aid the consumer in future coupon retrieval.

Pursuant to creating meaningful offers for consumers, the integrative vault provider will have a large amount of financial, spending pattern, and other data to examine to uncover hidden patterns, unknown correlations and other useful information. Such information can provide competitive advantages over rival organizations, such as financial institutions, and result in more effective marketing and new product offerings. In addition, much of this same data may be examined to uncover fraudulent and/or illegal activity.

Pursuant to all embodiments, any or all of the functions of the integrative vault 100/integrative vault provider, account aggregator provider 310, payment instrument issuer 320, digital wallet/digital wallet provider 330, merchant payment acceptance device or application 340, merchant website 350, payment processor/payment gateway 360, payment network 370, biller or biller consolidator 380 and/or other third parties may reside on common servers.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

It should be understood from the foregoing that a secure transaction processing system has been shown and described which enables an entity, such as a financial institution, to provide secure storage of a consumer's payment instruments, other instruments, and important documents in an integrative vault. The system has many desirable attributes and features that enable it to provide such functionality. Moreover, it is extremely flexible in that it can provide payment processing access, protection, management, control and auditability over all of the consumer's payment instruments, other instruments, and important documents.

Further, the integrative vault enables integration of all the consumer's financial account transactions across all payment channels into a singular application. This provides the consumer with a centralized view of all of his/her financial accounts enabling him/her to conveniently manage and control his/her financial assets. This centralized view enables a consumer to better budget and set financial goals, and is a prominent feature of the system of the present invention.

I claim:

1. A method for facilitating an electronic payment transaction request using an integrative vault system employing at least one server computer, the method comprising:
receiving and storing, by the at least one server computer of the integrative vault system, vault profile details and authentication credentials of a consumer;
receiving and storing, by the at least one server computer of the integrative vault system, data relating to a plurality of payment instruments associated with the consumer;
receiving and storing, by the at least one server computer of the integrative vault system, a payment determination strategy for the consumer for the plurality of payment instruments associated with the consumer;
receiving and storing, by the at least one server computer of the integrative vault system, data associated with at least one designated payment credential requestor;
receiving, by the at least one server computer of the integrative vault system, a payment credential request for the consumer including at least a portion of the authentication credentials of the consumer from the at least one designated payment credential requestor;
authenticating, by the at least one server computer of the integrative vault system, the at least a portion of the authentication credentials of the consumer;
determining, by the at least one server computer of the integrative vault system, one of the plurality of payment instruments associated with the consumer to use for the payment credential request based on the payment determination strategy for the consumer;
obtaining, by the at least one server computer of the integrative vault system, at least one payment credential for the one of the plurality of payment instruments associated with the consumer; and
providing, by the at least one server computer of the integrative vault system, the at least one payment credential to the at least one designated payment credential requestor to initiate the electronic payment transaction request into a payment network.

2. The method of claim 1, wherein the integrative vault system also employs at least one database for storing the integrative vault profile details, the authentication credentials, the data related to the plurality of payment instruments associated, and the payment determination strategy.

3. The method of claim 1, wherein the integrative vault system is configured to store vault profile details and authentication credentials for a plurality of consumers.

4. The method of claim 1, wherein the at least one server computer is configured to assign a default determination strategy for the payment determination strategy.

5. The method of claim 1, wherein the payment determination strategy is determined by the consumer.

6. The method of claim 1, wherein the integrative vault system is a multi-tenant service provider.

7. The method of claim 1, wherein the at least one payment credential is obtained from one of the consumer, a payment instrument issuer, and a third party.

8. The method of claim 1, further comprising determining whether the at least one payment credential has previously been provided to the at least one designated payment credential requestor.

9. The method of claim 1, wherein the payment credential request includes a token, and the token is reconciled by the integrative vault system to the one of the plurality of payment instruments specified by the payment determination strategy.

10. A method for facilitating an electronic payment transaction request using an integrative vault system employing at least one server computer, the method comprising:
receiving and storing, by the at least one server computer of the integrative vault system, vault profile details and authentication credentials of a consumer;
receiving and storing, by the at least one server computer of the integrative vault system, data relating to a plurality of payment instruments associated with the consumer;
receiving and storing, by the at least one server computer of the integrative vault system, an indication of whether a specific payment instrument of the plurality of payment instruments or a payment determination strategy to determine one of the plurality of payment instruments is to be used for a token;
receiving and storing, by the at least one server computer of the integrative vault system, data associated with at least one designated payment credential requestor;
receiving, by the at least one server computer of the integrative vault system, a token mediation request from the at least one designated payment credential requestor, the token mediation request comprising the token and a portion of the authentication credentials of the consumer, the token including information pertaining to an issuer of the token;
authenticating, by the at least one server computer of the integrative vault system, the portion of the authentication credentials of the consumer;
if the specified payment instrument is to be used for the token received in the token mediation request, obtaining, by the at least one server computer of the integrative vault system, at least one payment credential corresponding to the specific payment instrument of the plurality of payment instruments;
if the payment determination strategy is to be used for the token received in the token mediation request, obtaining, by the at least one server computer of the integrative vault system, at least one payment credential corresponding to the one of plurality of payment instruments determined by the payment determination strategy; and
providing, by the at least one server computer of the integrative vault system, the at least one payment credential to the at least one designated payment credential requestor for initiation of the electronic payment transaction request into a payment network.

11. The method of claim 10, wherein the at least one server computer is configured to assign a default determination strategy for the payment determination strategy.

12. The method of claim 10, wherein the payment determination strategy is determined by the consumer.

13. The method of claim 10, wherein the integrative vault system is a multi-tenant service provider.

14. The method of claim 10, further comprising determining whether the at least one payment credential has previously been provided to the at least one designated payment credential requestor.

15. The method of claim 10, further comprising reconciling, by the at least one server computer and in response to the token mediation request, the token to the specified payment instrument of the plurality of payment instruments or the one of the plurality of payment instruments determined by the payment determination strategy.

16. A method for facilitating an electronic payment transaction request using an integrative vault system employing at least one server computer, the method comprising:
receiving and storing, by the at least one server computer of the integrative vault system, vault profile details and authentication credentials of a consumer;
receiving and storing, by the at feast one server computer of the integrative vault system, data relating to a plurality of payment instruments associated with the consumer;
receiving and storing, by the at least one server computer of the integrative vault system, a payment determination strategy for the consumer for the plurality of payment instruments associated with the consumer;
receiving and storing, by the at least one server computer of the integrative vault system, data associated with at least one merchant;
receiving, by the at least one server computer of the integrative vault system, a consumer payment authorization request from the consumer, the consumer payment authorization request including at least a portion of the authentication credentials of the consumer, transactional and merchant details for the consumer payment authorization request, and one of an indication that a specified payment instrument and an indication that the payment determination strategy are to be used for the electronic payment transaction;
authenticating, by the at least one server computer of the integrative vault system, the at least a portion of the authentication credentials of the consumer;
if the indication that the specified payment instrument is to be used is received in the consumer payment authorization request, obtaining, by the at least one server computer of the integrative vault system, at least one payment credential corresponding to the specified payment instrument;
if the indication that the payment instrument strategy is to be used is received in the consumer payment authorization request, obtaining, by the at least one server computer of the integrative vault system, at least one payment credential corresponding to a payment instrument determined by the payment instrument strategy;
forwarding, by the at least one server computer of the integrative vault system, an authorization request including the at least one payment credential and the transactional details to an issuer of the at least one payment credential;
receiving, by the at least one server computer of the integrative vault system, a decision on the authorization request from the issuer of the at least one payment credential approving or declining the authorization request;
if the authorization request is approved by the issuer, forwarding, by the at least one server computer of the integrative vault system, an approved consumer authorization request into a payment network, the approved consumer authorization request being matched to a merchant payment authorization request to facilitate completion of the electronic payment transaction.

17. The method of claim 16, further comprising, if the authorization request is approved or declined, forwarding, by the at least one server computer of the integrative vault system, the decision on the authorization request to the consumer.

18. The method of claim 16, wherein the at least one server computer is configured to assign a default determination strategy for the payment determination strategy.

19. The method of claim 16, wherein the payment determination strategy is determined by the consumer.

20. The method of claim 16, wherein the integrative vault system is a multi-tenant service provider.

21. The method of claim 16, further comprising determining whether the at least one payment credential has previously been provided to the at least one designated payment credential requestor.
